(19) United States
(12) Patent Application Publication
(10) Pub. No.: US 2021/0027527 A1
(43) Pub. Date: Jan. 28, 2021

(54) IMAGE PROCESSING APPARATUS, DISPLAY APPARATUS, IMAGE PROCESSING METHOD, CONTROL PROGRAM, AND RECORDING MEDIUM

(71) Applicant: Sharp Kabushiki Kaisha, Sakai City, Osaka (JP)

(72) Inventor: Tomoyuki YAMAMOTO, Sakai City (JP)

(21) Appl. No.: 16/971,326

(22) PCT Filed: Feb. 20, 2019
(86) PCT No.: PCT/JP2019/006376

§ 371 Date: Aug. 20, 2020

(30) Foreign Application Priority Data
Feb. 27, 2018 (JP) 2018-033660

(51) Int. Cl. G06T 17/00; G06T 7/50; G06T 7/11; G06T 19/20; G06T 7/70; G06T 15/20

(52) U.S. Cl. CPC G06T 17/00; G06T 7/50; G06T 7/11; G06T 2207/30244; G06T 7/70; G06T 15/20; G06T 2219/2021; G06T 19/20

(57) ABSTRACT

The present invention provides a technique for suppressing deviation between the shape of a 3D model and the actual shape of an imaging target. An image processing apparatus (2) includes: an acquisition unit (7) configured to acquire an input depth for indicating a three-dimensional shape of an imaging target; a base model generation unit (9) configured to generate a base model based on a part of the input depth acquired by the acquisition unit; and a detailed model generation unit (10) configured to generate a detailed model of the imaging target, with reference to the input depth and the base model.

### TECHNICAL FIELD

An aspect of the present invention relates to an image processing apparatus configured to generate a three-dimensional model with reference to depth for indicating a three-dimensional shape of an imaging target.

BACKGROUND ART

In the field of CG, an approach of constructing a 3D model (three-dimensional model) by integrating input depth called DynamicFusion has been studied. The purpose of DynamicFusion is mainly to construct a 3D model from which noise is removed in real time from the imaged input depth. In DynamicFusion, the input depth obtained from sensors is integrated into a common reference 3D model after compensating for the deformation of a three-dimensional shape. This allows for the generation of a precise 3D model from low resolution and high noise depth.

More specifically, in DynamicFusion, the following steps (1) to (3) are performed.

(1) Estimate a camera pose (camera position or the like) and a deformation parameter (motion flow or the like), based on an input depth (current depth) and a reference 3D model (canonical model).

(2) Generate a live 3D model by deforming the reference 3D model with a deformation parameter.

(3) Update the reference 3D model by integrating the input depth into an appropriate position of the reference 3D model with reference to the camera pose and the deformation parameter.

An example of a document describing an approach using DynamicFusion as described above includes NPL 1.

### CITATION LIST

### Non Patent Literature

NPL 1: Richard A. Newcombe et al. “DynamicFusion: Reconstruction and tracking of non-rigid scenes in real-time” IEEE Conference on Computer Vision and Pattern Recognition (CVPR), Jun. 7, 2015

### SUMMARY OF INVENTION

### Technical Problem

In DynamicFusion described above, a reference 3D model is constructed based on an input depth of each time and a previous reference 3D model. However, in such a configuration, there is a problem in that, in a case that the shape of the reference 3D model is diverted from the actual shape of the imaging target once, due to an estimation error of a deformation parameter, noise of an input depth, a repair process of the reference 3D model, or the like, the quality of the subsequent reference 3D model deteriorates, and as a result, the quality of the output 3D model deteriorates.

An aspect of the present invention has been made in view of the problems described above, and an object of the present invention is to provide a technique for suppressing deviation between the shape of a 3D model and the actual shape of an imaging target.

### Solution to Problem

In order to solve the problem described above, an image processing apparatus according to an aspect of the present invention includes: an acquisition unit configured to acquire an input depth for indicating a three-dimensional shape of an imaging target; a base model generation unit configured to generate a base model based on a part of the input depth acquired by the acquisition unit; and a detailed model generation unit configured to generate a detailed model of the imaging target, with reference to the input depth and the base model.

In order to solve the problem described above, an image processing apparatus according to an aspect of the present invention includes the steps of: acquiring an input depth for indicating a three-dimensional shape of an imaging target; generating a base model based on a part of the input depth acquired in the acquisition step; and generating a detailed model of the imaging target, with reference to the input depth and the base model.

### Advantageous Effects of Invention

According to an aspect of the present invention, deviation between the shape of a 3D model and the actual shape of an imaging target can be suppressed.

### BRIEF DESCRIPTION OF DRAWINGS

FIG. 1 is a schematic diagram for illustrating an overview of a first embodiment of the present invention.

FIG. 2 is a block diagram illustrating a configuration of a display apparatus according to the first embodiment of the present invention.

FIG. 3 is a flowchart diagram for illustrating an example of an image processing method by an image processing apparatus according to the first embodiment of the present invention.

FIG. 4 is a block diagram illustrating a configuration of a depth region selection unit according to a specific example of the first embodiment of the present invention.

FIG. 5 is a flowchart diagram for illustrating a method for selecting a selection depth by a depth region selection unit according to a specific example of the first embodiment of the present invention.

FIG. 6 is a block diagram illustrating a configuration of a depth region selection unit according to a modification of the first embodiment of the present invention.

FIG. 7 is a flowchart diagram for illustrating a method for selecting a selection depth by a depth region selection unit according to a modification of the first embodiment of the present invention.

FIG. 8 is a block diagram illustrating a configuration of a base model generation unit according to a specific example of the first embodiment of the present invention.

FIG. 9 is a flowchart diagram for illustrating a method for generating a base model by a base model generation unit according to a specific example of the first embodiment of the present invention.

FIG. 10 is a block diagram illustrating a configuration of a base model generation unit according to a modification of the first embodiment of the present invention.

FIG. 11 is a flowchart diagram for illustrating a method for generating a base model by a base model according to a specific example of the first embodiment of the present invention.

FIG. 12 is a schematic diagram for illustrating an overview of a method for estimating a deformation parameter by a base model deformation estimation unit according to a specific example or a modification of the first embodiment of the present invention.

FIG. 13 is a flowchart diagram for illustrating a method for estimating a deformation parameter by a base model deformation estimation unit according to a specific example or a modification of the first embodiment of the present invention.

FIG. 14 is a block diagram illustrating a configuration of a detailed model generation unit according to a specific example of the first embodiment of the present invention.

FIG. 15 is a flowchart diagram for illustrating a method for generating a detailed model by a detailed model generation unit according to a specific example of the first embodiment of the present invention.

FIG. 16 is a schematic diagram for illustrating an overview of a method for estimating a base deformation parameter by a base deformation estimation unit and a method for estimating a deformation parameter by a detailed model deformation estimation unit according to a specific example of the first embodiment of the present invention.

FIG. 17 is a schematic diagram for illustrating an overview of a second embodiment of the present invention.

FIG. 18 is a block diagram illustrating a configuration of a display apparatus according to the second embodiment of the present invention.

FIG. 19 is a flowchart diagram illustrating an example of an image processing method by an image processing apparatus according to the second embodiment of the present invention.

FIG. 20 is a block diagram illustrating a configuration of a depth frame selection unit according to a specific example of the second embodiment of the present invention.

FIG. 21 is a flowchart diagram for illustrating a method for selecting a selection frame by a depth frame selection unit according to a specific example of the second embodiment of the present invention.

FIG. 22 is a schematic diagram illustrating an example of sublayer IDs.

FIG. 23 is a block diagram illustrating a configuration of a depth frame selection unit according to a modification of the present invention.

FIG. 24 is a flowchart diagram for illustrating a method for selecting a selection frame by a depth frame selection unit according to a modification of the present invention.

FIG. 25 is a schematic diagram for illustrating an overview of a third embodiment of the present invention.

FIG. 26 is a block diagram illustrating a configuration of a display apparatus according to the third embodiment of the present invention.

FIG. 27 is a flowchart diagram for illustrating an example of an image processing method by an image processing apparatus according to the third embodiment of the present invention.

### DESCRIPTION OF EMBODIMENTS

Embodiments of the present invention will be described below in detail. It should be noted that each constitution described in the present embodiments is not intended to exclusively limit the scope of this invention thereto as long as there is no specific description in particular, and is merely an example for description. Note that, in the first to third embodiments below, a configuration is described in which a rendering viewpoint image is generated by using a detailed model according to an aspect of the present invention (corresponding to a reference 3D model described above), but the image processing method using a detailed model according to an aspect of the present invention is not limited to the configuration. For example, in the technical field of three-dimensional imaging, a detailed model according to an aspect of the present invention may be used as appropriate.

### First Embodiment

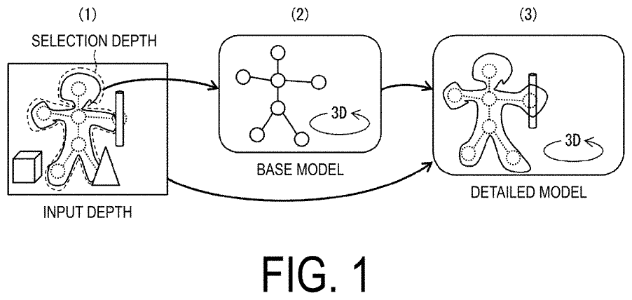

First, an overview of the first embodiment of the present invention will be described with reference to FIG. 1. FIG. 1 is a schematic diagram for illustrating an overview of the first embodiment of the present invention. The features of the first embodiment of the present invention include the following two points.

Feature 1: A region effective for generation of a base model with high reliability is extracted from an input depth at each time (representative example: a base model corresponding to a human skeleton is utilized to extract a depth region corresponding to a person).

Feature 2: The base model is generated based on the input depth and the base model, independent of a previous detailed model.

The following steps (1) to (3) are performed as main steps of the first embodiment.

(1) Extract a region of high certainty being a portion corresponding to a person (or other than a person) from an input depth as a selection depth.

(2) Generate a base model (corresponding to a human skeleton), based on the selection depth.

(3) Generate a detailed model from the base model and the input depth.

Image Processing Apparatus 2

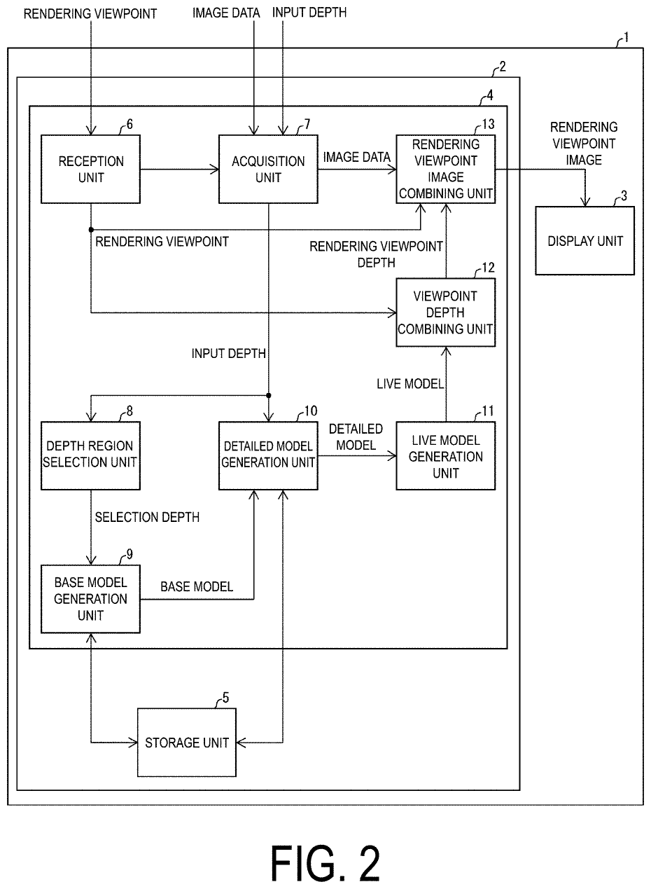

An image processing apparatus 2 according to the present embodiment will be described in detail with reference to FIG. 2. FIG. 2 is a block diagram illustrating a configuration of a display apparatus 1 according to the present embodiment. As illustrated in FIG. 2, the display apparatus 1 includes an image processing apparatus 2 and a display unit 3. The image processing apparatus 2 includes an image processing unit 4 and a storage unit 5, and the image processing unit 4 includes a reception unit 6, an acquisition unit 7, a depth region selection unit 8, a base model generation unit 9, a detailed model generation unit 10, a live model generation unit 11, a viewpoint depth combining unit 12, and a rendering viewpoint image combining unit 13.

The reception unit 6 receives a rendering viewpoint (information related to a rendering viewpoint) from the outside of the image processing apparatus 2.

The acquisition unit 7 acquires image data of the imaging target and an input depth (input depth at each time) for indicating the three-dimensional shape of the imaging target. Note that the term “image data” in the present specification indicates an image (color information of each pixel or the like) that indicates the imaging target from a specific viewpoint. Images in the present specification includes still images and videos.

The depth region selection unit 8 selects a selection depth from the input depth acquired by the acquisition unit 7.

The base model generation unit 9 generates (updates) a base model with reference to the selection depth selected by the depth region selection unit 8. In other words, the base model generation unit 9 generates a base model, based on a part of the input depth acquired by the acquisition unit 7.

The detailed model generation unit 10 generates (updates) a detailed model with reference to the input depth acquired by the acquisition unit 7 and the base model generated by the base model generation unit 9.

The live model generation unit 11 generates a live model with reference to the detailed model generated by the detailed model generation unit 10 and a deformation parameter.

The viewpoint depth combining unit 12 generates a rendering viewpoint depth, which is a depth from the rendering viewpoint to each portion of the imaging target, with reference to the rendering viewpoint received by the reception unit 6 and the live model generated by the live model generation unit 11.

The rendering viewpoint image combining unit 13 generates a rendering viewpoint image indicating the imaging target from the rendering viewpoint, with reference to the rendering viewpoint received by the reception unit 6, the image data acquired by the acquisition unit 7, and the rendering viewpoint depth generated by the viewpoint depth combining unit 12 (step S9).

The display unit 3 displays the rendering viewpoint image generated by the rendering viewpoint image combining unit 13.

The storage unit 5 stores the base model generated by the base model generation unit 9 and the detailed model generated by the detailed model generation unit 10.

Image Processing Method

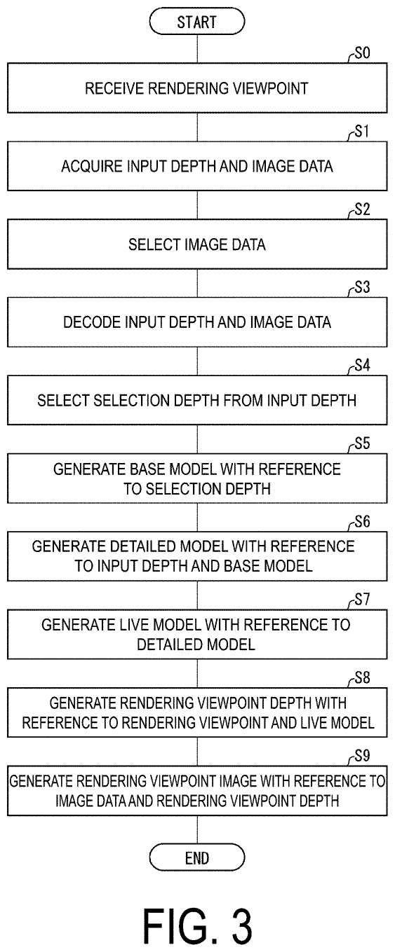

An image processing method by the image processing apparatus 2 according to the present embodiment will be described with reference to FIG. 3. FIG. 3 is a flowchart diagram for illustrating an example of an image processing method by the image processing apparatus 2 according to the present embodiment.

First, the reception unit 6 receives a rendering viewpoint (information related to a rendering viewpoint) from the outside of the image processing apparatus 2 (step S0). The reception unit 6 transmits the received rendering viewpoint to the acquisition unit 7, the viewpoint depth combining unit 12, and the rendering viewpoint image combining unit 13.

Next, the acquisition unit 7 acquires image data of the imaging target and an input depth (input depth at each time) for indicating the three-dimensional shape of the imaging target (step S1).

Next, the acquisition unit 7 selects image data to be decoded in the acquired image data in accordance with the rendering viewpoint received by the reception unit 6 (step S2).

Next, the acquisition unit 7 decodes the selected image data and the acquired input depth (step S3). Then, the acquisition unit 7 transmits the decoded image data to the rendering viewpoint image combining unit 13, and transmits the decoded input depth to the depth region selection unit 8 and the detailed model generation unit 10.

Next, the depth region selection unit 8 selects a selection depth from the input depth received from the acquisition unit 7 (step S4). More specifically, the depth region selection unit 8 extracts a partial depth region as a selection depth, based on a prescribed selection criterion, from the input depth. Then, the depth region selection unit 8 transmits the selected selection depth to the base model generation unit 9.

Next, the base model generation unit 9 generates (updates) a base model with reference to the selection depth received from the depth region selection unit 8 (step S5). More specifically, the base model generation unit 9 updates the base model with reference to the selection depth and a previously generated base model. Then, the base model generation unit 9 transmits the generated base model to the detailed model generation unit 10. As described above, a base model generated by the base model generation unit 9 is generated from only a selection depth and a previous base model, and therefore does not depend on a previous detailed model. In a case that the base model generation unit 9 has not previously generated a base model, the base model generation unit 9 may generate a base model with reference to only a selection depth.

Next, the detailed model generation unit 10 generates (updates) a detailed model with reference to the input depth received from the acquisition unit 7 and the base model received from the base model generation unit 9 (step S6). More specifically, the detailed model generation unit 10 updates the detailed model with reference to the base model, a previously generated detailed model, and the input depth. Then, the detailed model generation unit 10 transmits the generated detailed model and a deformation parameter described below to the live model generation unit 11. Note that in a case that the detailed model generation unit 10 has not previously generated a detailed model, the detailed model generation unit 10 may generate a detailed model with reference to only the base model and the input depth.

Next, the live model generation unit 11 generates a live model with reference to the detailed model and the deformation parameter received from the detailed model generation unit 10 (step S7). Then, the live model generation unit 11 transmits the generated live model to the viewpoint depth combining unit 12.

Next, the viewpoint depth combining unit 12 generates a rendering viewpoint depth, which is a depth from the rendering viewpoint to each portion of the imaging target, with reference to the rendering viewpoint received from the reception unit 6 and the live model generated by the live model generation unit 11 (step S8). Then, the viewpoint depth combining unit 12 transmits the generated rendering viewpoint depth to the rendering viewpoint image combining unit 13.

Next, the rendering viewpoint image combining unit 13 generates a rendering viewpoint image indicating the imaging target from the rendering viewpoint, with reference to the rendering viewpoint received from the reception unit 6, the image data received from the acquisition unit 7, and the rendering viewpoint depth received from the viewpoint depth combining unit 12 (step S9). Then, the rendering viewpoint image combining unit 13 transmits the generated rendering viewpoint image to the display unit 3. The display unit 3 displays the rendering viewpoint image received from the rendering viewpoint image combining unit 13.

Specific Example of Depth Region Selection Unit

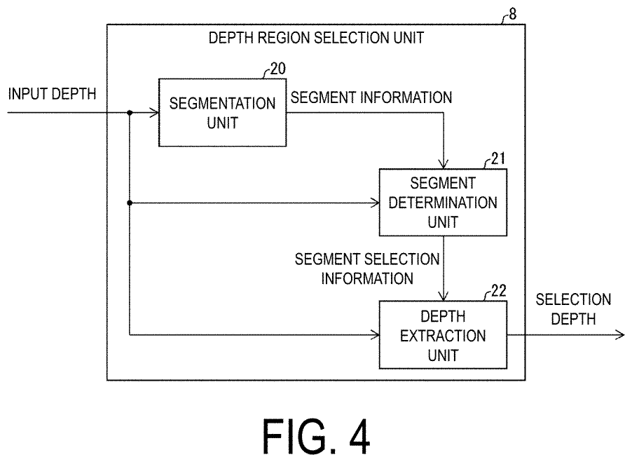

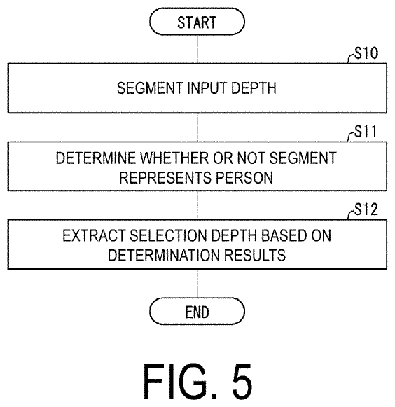

A specific example of a method for selecting a selection depth by the depth region selection unit 8 in step S4 described above will be described below with reference to FIG. 4 and FIG. 5. FIG. 4 is a block diagram illustrating a configuration of a depth region selection unit 8 according to the present specific example. As illustrated in FIG. 4, the depth region selection unit 8 according to the present specific example includes a segmentation unit 20, a segment determination unit 21, and a depth extraction unit 22. FIG. 5 is a flowchart diagram illustrating a method for selecting a selection depth by the depth region selection unit 8 according to the present specific example.

First, the segmentation unit 20 applies segmentation to the input depth received from the acquisition unit 7 (segmenting the input depth), and outputs information (segment information) for indicating the position and shape of the resulting segment group to the segment determination unit 21 (step S10). Here, the input depth segments are collections of depth that shares certain properties and can be expressed as a partial region on the image surface of the input depth.

Next, the segment determination unit 21 determines whether or not the target segment is a segment representing a person with reference to the segment information received from the segmentation unit 20, and outputs information for indicating a segment group determined to be a person (segment selection information) to the depth extraction unit 22. In other words, the segment determination unit 21 determines whether or not the target segment has reliable properties, and outputs segment selection information for indicating a segment group determined to have reliable properties to the depth extraction unit 22.

(Step S11)

Next, the depth extraction unit 22 extracts a depth corresponding to the segment indicated by the segment selection information described above as a selection depth from the input depth received from the acquisition unit 7, and outputs the selection depth to the base model generation unit 9 (step S12).

As described above, the depth region selection unit 8 (depth selection unit) according to the present specific example includes a segmentation unit 20 configured to segment the input depth and a depth extraction unit 22 (selection depth extraction unit) configured to extract an input depth corresponding to the imaging target as a selection depth from the input depth resulting from the segmentation by the segmentation unit 20.

According to the configuration described above, an input depth with high reliability can be selected as a selection depth by extracting a segment with high reliability by determining the reliability of the input depth segment with a prescribed criterion. Accordingly, a base model with high reliability based on the selection depth can be generated, and deviation between the shape of the detailed model and the shape of the imaging target can be suppressed.

Variation of Specific Example of Depth Region Selection Unit

A more detailed example of the specific example of the depth region selection unit 8 described above will be described below. First, an example of a target to be selected as a selection depth by the depth region selection unit 8 by using the segment determination in steps S10 to S12 described above will be described. For example, the depth region selection unit 8 may be configured to select a region corresponding to another target from the input depth in accordance with the imaging target, not limited to a person. As a result, the image processing method according to the present embodiment can also be applied to a case that other than a person is a target.

In a case that multiple different types of targets are present in the imaging target scene, a segment with high reliability may be extracted for each type of target. More specifically, an imaging target configuration unit may be additionally provided in the depth region selection unit 8, the imaging target configuration unit may configure the type of target (e.g., a person, background, or the like) as a determination target, and the segment determination unit 21 may determine whether or not the target segment is a segment representing the determination target configured by the imaging target configuration unit in step S11 described above. As a result, the image processing method according to the present embodiment can also be applied in a case of imaging more diverse targets.

Next, an example of performing filtering according to noise conditions by the depth region selection unit 8 will be described. For example, the depth region selection unit 8 may be configured to perform filtering on the input depth according to noise conditions. More particularly, in step S11 described above, the segment determination unit 21 may be configured to not select a segment with a lot of noise by determining the noise conditions of the segments and outputting only segment selection information for the segments with relatively little noise to the depth extraction unit 22. In this configuration, for example, the segment determination unit 21 may determine that there is a lot of noise in a case that there is a large dispersion between nearby samples in the depth within the same segment. This can improve the quality of the base model since the base model can be updated with a depth having less noise in subsequent steps.

Next, an example of selecting a segment by using a base model by the depth region selection unit 8 will be described. For example, the depth region selection unit 8 may be configured to select a segment with reference to a base model previously generated by the base model generation unit 9. More specifically, the segment determination unit 21 may refer to the positions (for example, the joint positions) of the three-dimensional feature points of the base model at an immediately preceding time, may determine whether or not the target segment is sufficiently close to the three-dimensional feature points, and may output information for indicating the target segment to the depth extraction unit 22 in a case that the symmetric segment is determined to be sufficiently close to the three-dimensional feature point positions. Here, the three-dimensional feature points and the determination criteria for determining that the target segment is sufficiently close to the three-dimensional feature points are preferably configures so as to cover the entire base model to the minimum necessary. For example, it is preferable to configure joint positions as three-dimensional feature points for a human base model and use determination criteria corresponding to the distances between each point of the body surface and the nearby joint. In this way, it is possible to remove depth segments corresponding to positions outside the expected shape of the target, and thus, the selection rate of wrong segments can be reduced even in a case that multiple objects are present.

Positions of nodes (deformation nodes) for controlling a deformation of the base model may be configured as three-dimensional feature points. Since the deformation nodes are often placed in positions preferable for representing a deformation of the base model, depth corresponding to the vicinity of the deformation nodes is important. Configuring three-dimensional feature points to positions of deformation nodes allows for deformation estimation of a base model with high reliability by preferentially selecting segments that include important depth.

Next, an example of the types of selection depth selected by the depth region selection unit 8 will be described. For example, the depth region selection unit 8 may be configured to configure a prescribed invalid value to regions other than regions of segments not determined to be a prescribed target type (e.g., a person) after performing step S11. The depth region selection unit 8 may be configured to output the input depth and the selection segment information to the base model generation unit 9 instead of the selection depth without performing step S12 described above. This may require subsequent processing to extract the depth, but can avoid memory gain of the depth. The depth region selection unit 8 may be configured to convert the selection depth into a three-dimensional point group after step S12 described above and output. As a result, the three-dimensional point group and the 3D model can be directly compared in a subsequent block (step S5 or the like), and thus the amount of processing can be reduced.

Next, an example of preferentially selecting a central portion of the depth by the depth region selection unit 8 will be described. For example, the depth region selection unit 8 may be configured to select a sample or segment as a selection depth in a case that the sample or segment is in the vicinity of the depth center (center of the depth image). The reason for employing this configuration is that in a case that a depth of the image periphery is used, the reliability of the deformation estimation will be reduced due to the influence of frame in/frame out due to the movement of the imaging target or the depth camera.

An example of performing sampling by the depth region selection unit 8 will be described. The depth region selection unit 8 may be configured to select a selection depth from the depth that has been thinned out by space sampling. The reason for employing this configuration is that using an excessive number of depths causes a decrease in the accuracy of the deformation estimation, and leads to an increase in the execution time of the deformation estimation. The depth region selection unit 8 may be configured to space sample a portion of the depth at a density in accordance with the characteristics of the base model. More specifically, for example, the depth region selection unit 8 may sample a place densely where multiple nodes (deformation nodes) are placed and sparsely a place where a few nodes are placed in the base model. By employing the configuration described above, a large number of samples are used in a place where the number of nodes is large since the degree of freedom of deformation is high, and conversely a small number of samples are used in a place where the nodes are sparse, so the accuracy of the deformation estimation can be improved and a base model with high reliability can be constructed.

Modification of Depth Region Selection Unit

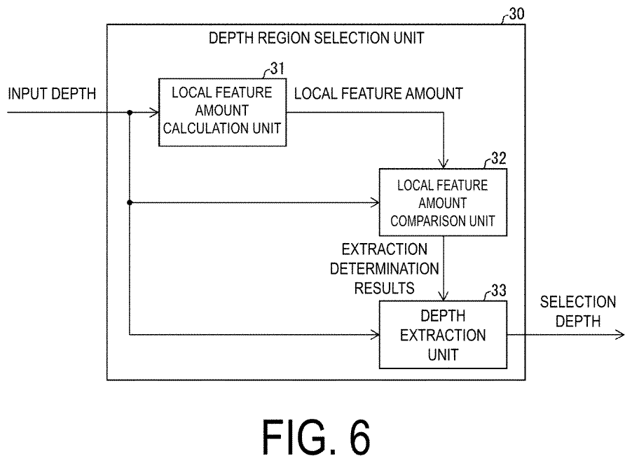

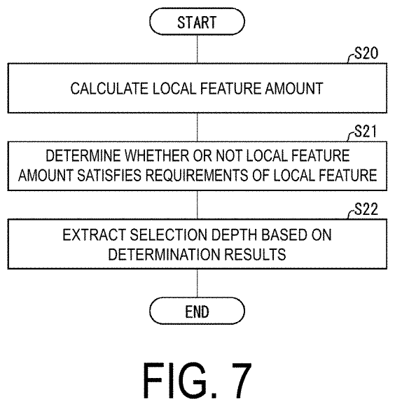

A modification of a method for selecting a selection depth by the depth region selection unit 8 in step S4 described above will be described below with reference to FIG. 6 and FIG. 7. FIG. 6 is a block diagram illustrating a configuration of a depth region selection unit 30 according to the present modification. As illustrated in FIG. 6, the depth region selection unit 30 according to the present modification includes a local feature amount calculation unit 31, a local feature amount comparison unit 32, and a depth extraction unit 33. FIG. 7 is a flowchart diagram for illustrating a method for selecting a selection depth by the depth region selection unit 30 according to the present modification.

First, the local feature amount calculation unit 31 calculates an amount of local feature for each sample with reference to the input depth received from the acquisition unit 7 (step S20). More specifically, the local feature amount calculation unit 31 calculates a three-dimensional feature amount (normal, curvature, edge strength, variance, or the like) of a sample placed in the vicinity of the target sample, and outputs the calculated three-dimensional feature amount to the local feature amount comparison unit 32.

Next, the local feature amount comparison unit 32 determines whether or not the local feature amount received from the local feature amount calculation unit 31 satisfies the requirements of the local feature in the base model of the applying target, and outputs the determination results (segment selection information) to the depth extraction unit 33 (step S21). More specifically, for example, in a case that the requirements of the local feature in the base model of the applying target is to have a smooth surface, the local feature amount comparison unit 32 determines whether or not the normal change is small and the curvature, the edge strength, and the variance are less than or equal to a prescribed value.

Next, the depth extraction unit 33 extracts a depth corresponding to the segment indicated by the segment selection information described above as a selection depth from the input depth received from the acquisition unit 7, and outputs the selection depth to the base model generation unit 9 (step S22).

Calculation of Local Feature Amount by Utilizing Base Model

In the above description of the local feature amount calculation unit 31, the local feature amount is calculated with reference to the input depth, but a configuration is possible in which an amount of local feature for each sample derived also using the input depth and the base model is calculated.

In the following, a pair constituted of a depth sample and a corresponding base model vertex is referred to as a depth model pair. The depth model pair is assumed to be given as cues in the deformation parameter estimation of the base model and for example, the nearest base model vertex of the depth sample is selected as the pair. There is also a method of selecting a base model vertex projected to the same pixel position in a case of projecting to the depth image as a pair.

The local feature amount calculation unit 31 may be configured to calculate the local feature amount with reference to the depth sample pair. Specifically, the distance between the two points constituting the depth sample pair is calculated as the local feature amount. In this case, by selecting a depth sample having a sufficiently small distance between two points by the local feature amount comparison unit 32, it is possible to suppress an erroneous deformation parameter from being derived by inputting a large error depth sample pair at the time of estimation of the base model deformation parameter.

In another specific example, the distance between a vertex that constitutes the depth sample pair and a deformation node is an amount of local feature. In general, the reliability of deformation decreases as the distance from the deformation node increases, so the accuracy of the deformation parameter estimation of the base model generation unit is improved by selecting a depth sample having the sufficiently small distance by the local feature amount comparison unit 32.

In another specific example, the number of vertices constituting the depth sample pair and the number of nearby deformation nodes of the vertices are defined as an amount of local feature. In general, in a case that the number of nearby deformation nodes of the vertices is small, the reliability of deformation at the vertices decreases as compared to a case that there is a large number of nearby deformation nodes of the vertices. In this case, by selecting a depth sample whose number of nearby deformation nodes is greater than a prescribed value by the local feature amount comparison unit 32, the accuracy of the deformation parameter estimation of the base model generation unit is improved.

A configuration is also possible in which the number of base model vertices present in the vicinity of the depth sample is an amount of local feature. By configuring the local feature amount comparison unit 32 to select a depth sample having the number of vertices greater than or equal to a certain number, it is possible to reduce the possibility that a end of the base model or an erroneously generated surface are used as a depth sample pair, and the estimation accuracy of the deformation parameter of the base model is improved. Note that instead of the number of nearby base model vertices, an average distance between the depth sample and a distance model vertex within a prescribed distance may be used.

As described above, the depth region selection unit 30 (depth selection unit) according to the present modification includes an amount of local feature calculation unit 31 configured to calculate an amount of local feature of the input depth, and a depth extraction unit 22 (selection depth extraction unit) configured to extract a selection depth from the input depth with reference to the local feature amount.

According to the configuration described above, an input depth with high reliability can be selected as a selection depth, based on an amount of local feature. Accordingly, a base model with high reliability based on the selection depth can be generated, and deviation between the shape of the detailed model and the shape of the imaging target can be suppressed.

Specific Example of Base Model Generation Unit

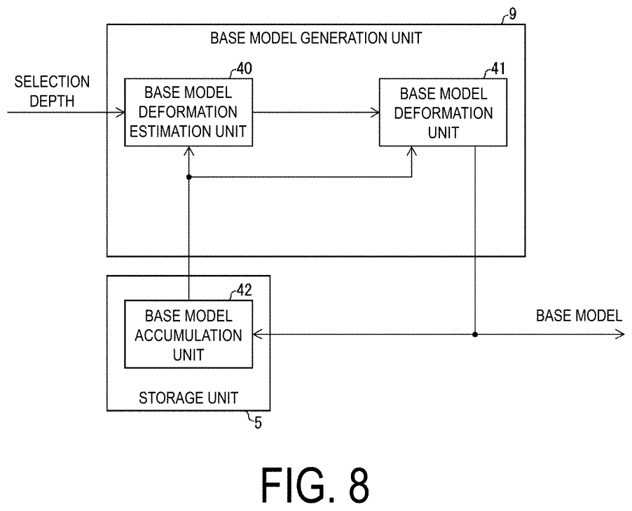

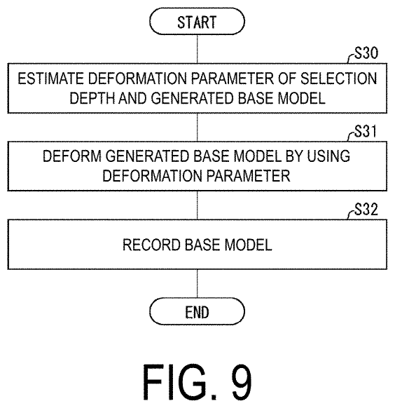

A specific example of a method for generating a base model by the base model generation unit 9 in step S5 described above will be described below with reference to FIG. 8 and FIG. 9. FIG. 8 is a block diagram illustrating a configuration of a base model generation unit 9 according to the present specific example. As illustrated in FIG. 8, the base model generation unit 9 according to the present specific example includes a base model deformation estimation unit 40 and a base model deformation unit 41, and the storage unit 5 includes a base model accumulation unit 42. FIG. 9 is a flowchart diagram for illustrating a method for generating a base model by the base model generation unit 9 according to the present specific example.

First, the base model deformation estimation unit 40 estimates a deformation parameter of each deformation node (corresponding to a joint) of the base model, based on the selection depth received from the depth region selection unit 8 and the derived base model, and transmits the deformation parameter to the base model deformation unit 41. (step S30). Here, by the base model deformation estimation unit 40 utilizing the selection depth rather than the input depth, the estimation error rate of the deformation parameter can be reduced.

Next, the base model deformation unit 41 generates a new base model by deforming a previous base model by using the deformation parameter received from the base model deformation estimation unit 40, and transmits the new base model to the detailed model generation unit 10 and the base model accumulation unit 42 (step S31).

Next, the base model accumulation unit 42 records the base model received from the base model deformation unit 41 for subsequent processing (step S32). Here, the base model stored in the base model accumulation unit 42 is referred to in a case that the base model deformation estimation unit 40 estimates a deformation parameter of a subsequent base model.

In summary, in the configuration described above, a base model depends only on a selection depth and a previously generated base model, and does not depend on a previously generated detailed model. Therefore, even in a case that the shape of the detailed model and the actual shape of the imaging target begin to be diverted (deterioration of the detailed model), the deterioration does not propagate to the base model.

As described above, the base model generation unit 9 according to the present specific example includes a base model deformation estimation unit 40 (deformation parameter estimation unit) configured to estimate a deformation parameter of a selection depth and a generated base model, and a base model deformation unit 41 configure to update a base model by deforming the generated base model by using the deformation parameter.

According to the configuration described above, the base model is updated based on the deformation parameter of the selection depth and the generated base model. Here, a base model with high reliability can be generated by using a selection depth with high reliability. Accordingly, deviation between the shape of the detailed model and the shape of the imaging target can be suppressed.

Modification of Base Model Generation Unit 9

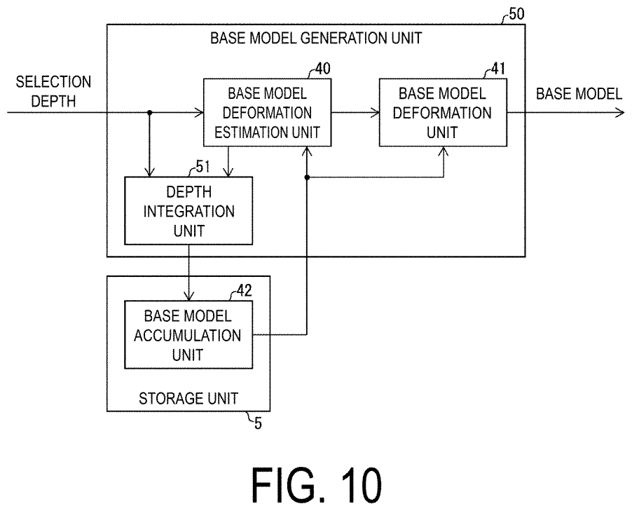

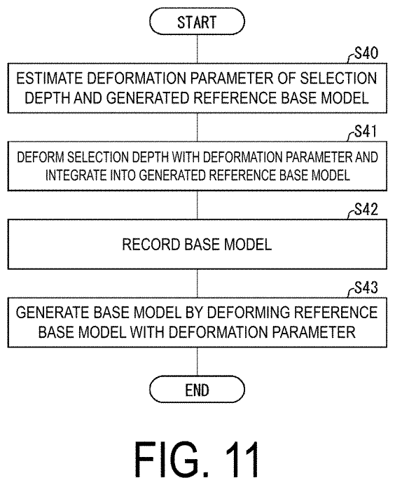

A modification of a method for generating a base model by the base model generation unit 9 in step S5 described above will be described below with reference to FIG. 10 and FIG. 11. FIG. 10 is a block diagram illustrating a configuration of a base model generation unit 50 according to the present modification. As illustrated in FIG. 10, the base model generation unit 50 according to the present modification further includes a depth integration unit 51 in addition to the configuration of the base model generation unit 9 and the storage unit 5 described above. FIG. 11 is a flowchart diagram for illustrating a method for generating a base model by the base model generation unit 50 according to the present modification.

First, the base model deformation estimation unit 40 estimates a deformation parameter of each deformation node (corresponding to a joint) of the reference base model, based on the selection depth received from the depth region selection unit 8 and the derived reference base model, and transmits the deformation parameter to the depth integration unit 51 and the base model deformation unit 41. (step S40).

Next, the depth integration unit 51 deforms the selection depth received from the depth region selection unit 8 with the deformation parameter received from the base model deformation estimation unit 40, integrates the deformation parameter into the derived reference base model, and transmits the reference base model to the base model accumulation unit 42 (step S41).

Next, the base model accumulation unit 42 records the reference base model received from the depth integration unit 51 for subsequent processing (step S42).

Next, the base model deformation unit 41 generates a base model by deforming the reference base model recorded by the base model accumulation unit 42 by using the deformation parameter received from the base model deformation estimation unit 40, and transmits the generated base model to the detailed model generation unit 10 (step S43).

As described above, the base model generation unit 9 according to the present modification includes a base model deformation estimation unit 40 (deformation parameter estimation unit) configured to estimate a deformation parameter of a selection depth and a generated base model, a depth integration unit 51 (reference base model generation unit) configured to deform a selection depth by using the deformation parameter and generate a reference base model with reference to the selection depth, and a base model deformation unit 41 (reference base model deformation unit) configured to generate the base model by deforming the reference base model by using the deformation parameter.

According to the configuration described above, a base model can be generated by using a reference base model based on a deformation parameter of a selection depth and a generated base model. As a result, a base model with high reliability can be generated, and deviation between the shape of the detailed model and the shape of the imaging target can be suppressed.

Specific Example of Base Model Deformation Estimation Unit

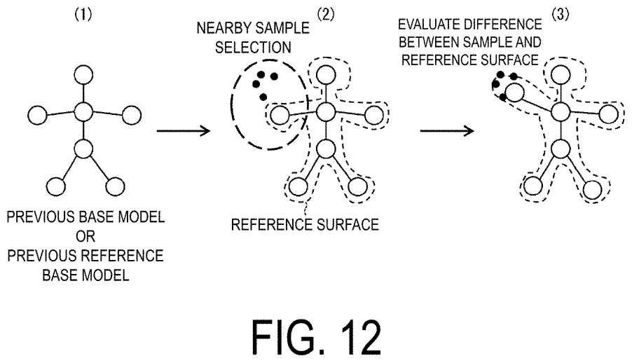

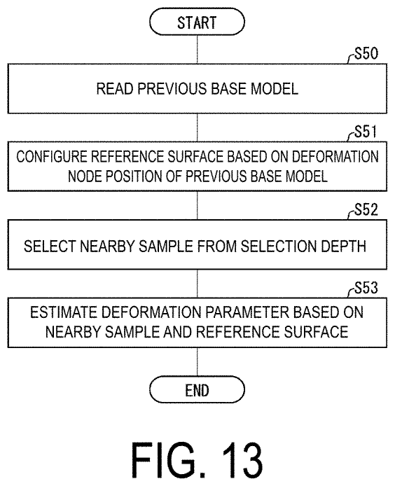

A specific example of a method for estimating a deformation parameter by the base model deformation estimation unit 40 in steps S30 and S40 described above will be described below with reference to FIG. 12 and FIG. 13. FIG. 12 is a schematic diagram for illustrating an overview of a method for estimating a deformation parameter by the base model deformation estimation unit 40 according to the present specific example. FIG. 13 is a flowchart diagram for illustrating a method for estimating a deformation parameter by the base model deformation estimation unit 40 according to the present specific example.

First, the base model deformation estimation unit 40 reads a previous base model (or a previous reference base model) from the base model accumulation unit 42 (step S50) (FIG. 12 (1)). Here, the previous base model is a base model that has been previously generated and recorded in the accumulation model accumulation unit 42, and does not necessarily have to be a base model corresponding to the target at a past time.

Next, the base model deformation estimation unit 40 configures the reference surface (dotted line in FIG. 12 (2)), based on the deformation node positions of the read previous base model (or previous reference base model) (step S51). Note that, in a case of a person, the reference surface here corresponds to the body surface with respect to the joint positions, and the reference surface can be generated from a databased relationship between the joint positions and the body surface.

Next, the base model deformation estimation unit 40 selects a depth sample (nearby sample) (multiple points in FIG. 12 (2)) that is present in the vicinity of the node from the selection depth received from the depth region selection unit 8 (step S52).

Next, the base model deformation estimation unit 40 calculates a deformation parameter of the deformation node that minimizes the error between the position of the nearby sample and the position of the reference surface (step S53) (FIG. 12 (3)). More specifically, for example, the base model deformation estimation unit 40 can derive a deformation parameter of the deformation node by solving a least squares optimization using the square of the error as a cost function.

As described above, the base model deformation estimation unit 40 according to the present specific example estimates the deformation of each portion by adjusting the position of the surface of the base model to the position of the nearby selection depth. In the conventional technology, the depth includes data corresponding to a target (background or the like) other than the imaging target (person) or noise, and there is a problem in that the reliability of the deformation estimation is low. However, in the configuration described above, the reliability of the deformation estimation can be improved since a selection depth with high reliability is used.

Specific Example of Detailed Model Generation Unit

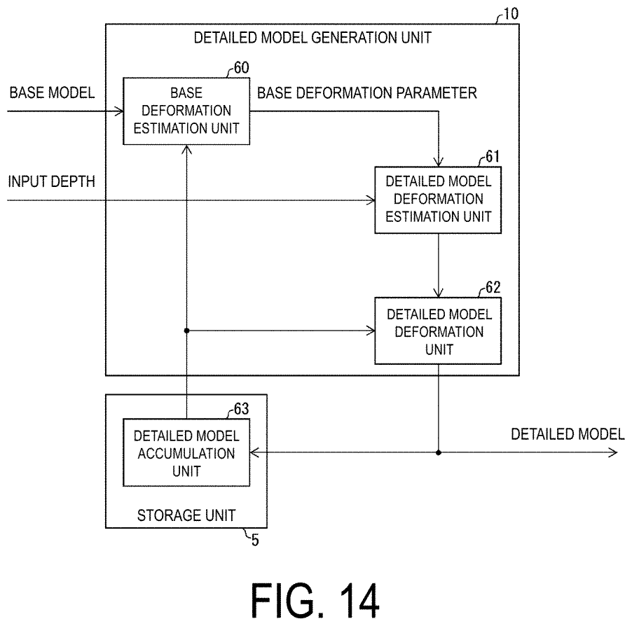

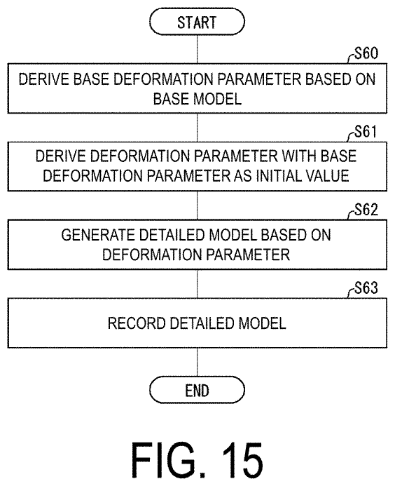

A specific example of a method for generating a detailed model by the detailed model generation unit 10 in step S6 described above will be described below with reference to FIG. 14 and FIG. 15. FIG. 14 is a block diagram illustrating a configuration of the detailed model generation unit 10 according to the present specific example. As illustrated in FIG. 14, the detailed model generation unit 10 according to the present specific example includes a base deformation estimation unit 60, a detailed model deformation estimation unit 61, and a detailed model deformation unit 62, and the storage unit 5 includes a detailed model accumulation unit 63. FIG. 15 is a flowchart diagram for illustrating a method for generating a detailed model by the detailed model generation unit 10 according to the present specific example.

First, the base deformation estimation unit 60 derives a base deformation parameter, based on the base model received from the base model generation unit 9 and a previously generated detailed model, and transmits the derived base deformation parameter to the detailed model deformation estimation unit 61 (step S60). In other words, the base deformation estimation unit 60 performs a primary estimation of the detailed model with reference to the base model with high reliability.

Next, the detailed model deformation estimation unit 61 derives a deformation parameter of the input depth (received from the acquisition unit 7) and the generated detailed model, with the base deformation parameter received from the base deformation estimation unit 60 as an initial value, and transmits the derived deformation parameter to the detailed model deformation unit 62 (step S61).

Next, the detailed model deformation unit 62 generate a detailed model by deforming the previous detailed model, based on the deformation parameter received from the detailed model deformation estimation unit 61, and transmits the detailed model to the live model generation unit 11 and the detailed model accumulation unit 63 (step S62). That is, the detailed model deformation unit 62 deforms the previous detailed model by using a deformation parameter using an estimated value (base deformation parameter) based on a base model with high reliability as an initial value. As a result, even in a case that the shape of the detailed model and the actual shape of the imaging target begin to be diverted (deterioration of the detailed model), the deterioration can be suppressed from propagating to a subsequent detailed model, and the quality of the detailed model can be improved.

As a next step of step S62, the detailed model accumulation unit 63 records the detailed model received from the detailed model deformation unit 62 (step S63).

As described above, the detailed model generation unit 10 according to the present specific example includes a base deformation estimation unit 60 (base deformation parameter estimation unit) configured to estimate a base deformation parameter of a base model and a generated detailed model, a detailed model deformation estimation unit 61 (detailed model deformation parameter estimation unit) configured to estimate a detailed model deformation parameter of an input depth and the generated detailed model, by using the base deformation parameter as an initial value, and a detailed model deformation unit 62 configured to update a detailed model by deforming the generated detailed model by using the detailed model deformation parameter.

According to the configuration described above, a detailed model deformation parameter is estimated based on a base deformation parameter estimated from a base model. As a result, a detailed model can be updated by using a detailed model deformation parameter with high reliability based on the base model, and thus deviation between the shape of the detailed model and the shape of the imaging target can be suppressed.

Specific Example of Base Deformation Estimation Unit and Detailed Model Deformation Estimation Unit

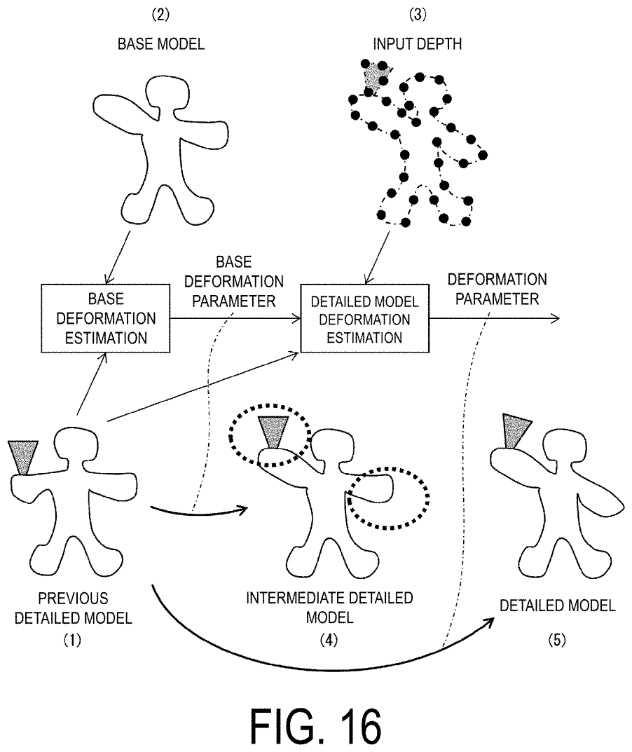

A specific example of a method for estimating a base deformation parameter by the base deformation estimation unit 60 in step S60 described above, and a method for estimating a deformation parameter by the detailed model deformation estimation unit 61 in step S61 described above will be described below with reference to FIG. 16. FIG. 16 is a schematic diagram for illustrating an overview of a method for estimating a base deformation parameter by the base deformation estimation unit 60 in step S60 described above, and a method for estimating a deformation parameter by the detailed model deformation estimation unit 61 in step S61 described above according to the present specific example.

In step S60 described above, the base deformation estimation unit 60 derives a base deformation parameter by which the previous detailed model (FIG. 16 (1)) gets closer to the base model (FIG. 16 (2)). More particularly, for example, the base deformation estimation unit 60 configures points on the base model corresponding to each vertex of the previous detailed model, and derives a base deformation parameter by which each point of the both gets closer.

In step S61 described above, the detailed model deformation estimation unit 61 derives a deformation parameter by which the previous detailed model gets closer to the input depth (FIG. 16 (3)), by using the base deformation parameter estimated by the base deformation estimation unit 60 as an initial value. More specifically, for example, the detailed model deformation estimation unit 61 configures points of the input depth corresponding to each vertex of the previous detailed model, and searches for a deformation parameter by which each point of the both gets closer, mainly on the base deformation parameter (search for a value in the vicinity of the base deformation parameter). In another example, the detailed model deformation estimation unit 61 generates an intermediate detailed model (FIG. 16 (4)) to which the previous detailed model has been deformed with the base deformation parameter, estimates a difference deformation parameter by which the intermediate detailed model and the input depth get closer, and derives a deformation parameter representing the synthesis of the deformation by the base deformation parameter and the deformation by the difference deformation parameter.

By employing the configuration described above, an intermediate detailed model is generated with reference to a base deformation parameter based on a base model, so that in the generation of the intermediate detailed model, the target of the base model (part of a person in the example above) can be accurately deformed by using information with high reliability. On the other hand, a target other than a person, or a sudden deformation (a portion surrounded by a dotted line in FIG. 16 (4)) or the like may not be reflected to the base model. Thus, in the derivation of a final deformation parameter, the final deformation can be determined by further referencing the input depth to construct a detailed model (FIG. 16 (5)) supporting such a case.

Details of Base Model Generation Unit According to First Embodiment

Definition

The following lists definitions of data used by the base model generation unit 9 according to the present embodiment.

Selection depth D: Depth value indexed at the position u, v on the image. An invalid value is configured for an unselected depth

Base model M: Set of base nodes {Ni|i=1, . . . , n} n is the number of base nodes

Base node Ni: Node (corresponding to joint) presents at the position {xi, yi, zi} at the reference time. Reference surface S: a vertex group generated based on the positions of the base nodes from the base model (e.g., a statistical relationship between human joint positions and the body surface is used)

Deformation parameter W: Set of base node deformation W={Wi|i=1, . . . , n}

Base node deformation Wi: Deformation from the reference time to the target time Wi={rx, ry, rz, tx, ty, tz}

tx, ty, tz is a translation of each axis, rx, ry, rz is a rotation around each axis

Base Model Deformation Estimation

Next, details of the base model deformation estimation by the base model generation unit 9 according to the present embodiment are described below. Note that in the following details, the target time is equal to t, and the reference time is equal to t−1.

Derive W^{t} from D^{t}, M^{t-1} (corresponding to step S30 described above)

Derive Wi^{t} by performing the following process on each base node Ni^{t-1}

1) Select a depth in the vicinity of Ni from the selection depth D^{t}, and derive a set of points Pi^{t} corresponding to the selected depth (corresponding to step S52 described above)

Pi^{t}={pi|L2(p, Ni)<th}

Here, pi is points in space obtained by backprojection of depth D^{t}, and th is a threshold value of vicinity determination (e.g., by using the average distance between base nodes)

L2 (a, b) is the distance between a and b

2) Determine a base deformation parameter Wi^{t} by which the average distance between each point of Pi^{t} and the reference surface S^{t} after deformation is minimized (corresponding to step S53 described above)

Derive the reference surface S^{t} by deforming the reference surface S^{t-1} in the vicinity of the base node Ni^{t-1}, based on the deformation W^{t}i

s^{t}=Ri^{t}(s^{t-1}−Ni^{t-1})+Ni^{t-1}+Ti^{t}

argmin (wᵢₜ) Σᵢ (L2(pi, g(S^{t}, pi)) Here, g(S^{t}, pi) is a function that selects a nearby point of pi from S^{t}

Here, R^{t} corresponds to the rotation represented by {rx, ry, rz}, and T^{t} corresponds to the translation represented by {tx, ty, tz}.

Base Model Deformation

Next, details of the base model deformation by the base model generation unit 9 according to the present embodiment are described below.

Derive M^{t} by deforming M^{t-1} with W^{t} (corresponding to step S31 described above)

Determine Ni^{t} by deforming each base node Ni^{t-1} with the deformation Wi^{t}

Ni^{t}=R^{t}Ni^{t-1}+T^{t}

Details of Detailed Model Generation Unit According to First Embodiment

Definition

The following lists definitions of data used by the detailed model generation unit 10 according to the present embodiment. Note that the data used by the base model generation unit 9 according to the present embodiment described above is also used by the detailed model generation unit 10, but is omitted in the following.

Detailed model Md: Set of vertices {pdi|i=1, . . . , n} n is the number of vertices

Base deformation parameter Wb: Set of deformation node deformation parameters Wb={Wbi|i=1, . . . , n} n is the number of deformation nodes

Detailed deformation parameter Wd: Set of deformation node deformation parameters Wd={Wdi|i=1, . . . , n} n is the number of deformation nodes

Base Deformation Estimation

Details of the base model deformation estimation by the detailed model generation unit 10 according to the present embodiment are described below.

Derive Wb^{t} from M^{t}, Md^{t-1} (corresponding to step S60 described above)

1) Configure positions of deformation nodes, based on vertices of Md^{t-1}
Configure the positions of the points subsampled as the vertices are at a certain interval to be the deformation nodes

2) Derive a base deformation parameter Wbi for each deformation node wi by the following procedure
Determine Wbi by the same procedure as the base model deformation estimation processing of the base model generation unit 9. However, the following changes are made. Reference surface→detailed model, base node→deformation node, depth→reference surface of base model.

Note that, there is a difference that the deformation parameter of the base deformation node by which the reference surface gets closer to the depth is derived in the estimation processing of the base model generation unit 9, and on the other hand, the deformation parameter of the deformation node by which the detailed model gets closer to the base model reference surface is derived in the estimation processing in the detailed model generation unit 10.

Detailed Deformation Estimation (Corresponding to Step S61 Described Above)

The method of deriving the detailed deformation parameter Wd^{t} of the deformation node by which the detailed model Md^{t-1} gets closer to the input depth D^{t} is the same as that of the base deformation estimation unit, but the base deformation parameter is used as the initial value of the deformation parameter.

Detailed Model Deformation (Corresponding to Step S62 Described Above)

Derive the detailed model M^{t} by deforming the detailed model Md^{t-1} by using the detailed deformation parameter Wd^{t}

This step is similar to the base model deformation.

### Summary of First Embodiment

As described above, the image processing apparatus 2 according to the present embodiment includes an acquisition unit 7 configured to acquire an input depth for indicating a three-dimensional shape of the imaging target, a base model generation unit 9 configured to generate a base model, based on a part of the input depth acquired by the acquisition unit 7, and a detailed model generation unit 10 configured to generate a detailed model of the imaging target with reference to the input depth and the base model.

According to the configuration described above, unlike a case that a detailed model is generated directly from an input depth, a base model is first generated and the base model is further referenced to generate a detailed model. Accordingly, by generating a base model, based on data with high reliability as appropriate, deviation between the shape of a detailed model and the shape of an imaging target can be suppressed (a reduction in the quality of a detailed model can be suppressed). Even in a case that the shape of the detailed model and the shape of the imaging target begin to be diverted, it is possible to suppress influence of the deviation to the base model, and the reliability of the base model can be maintained. Accordingly, deviation between the shape of the detailed model and the shape of the imaging target can be suppressed.

More specifically, the image processing apparatus 2 according to the present embodiment further includes a depth region selection unit 8 (depth selection unit) configured to select a selection depth from the input depth acquired by the acquisition unit 7, and the base model generation unit 9 generates a base model with reference to the selection depth.

According to the configuration described above, by selecting a selection depth with high reliability as appropriate, a base model with high reliability based on the selection depth can be generated. Accordingly, deviation between the shape of the detailed model and the shape of the imaging target can be suppressed.

### Second Embodiment

The second embodiment of the present invention will be described as follows with reference to the drawings. Note that, members having the same functions as the members included in the image processing apparatus 2 described in the first embodiment are added the same signs and description thereof will be omitted.

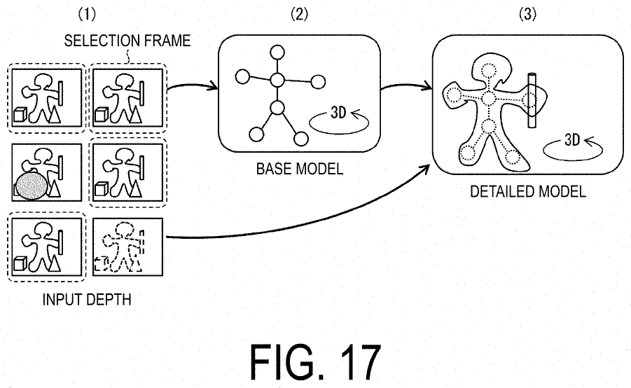

First, an overview of the second embodiment of the present invention will be described with reference to FIG. 17. FIG. 17 is a schematic diagram for illustrating an overview of the second embodiment of the present invention. The features of the second embodiment of the present invention include the following two points.

Feature 1: A frame effective for generation of a base model with high reliability is extracted from an input depth (representative example: a frame with high quality (such as low noise) is extracted from the input depth for use).

Feature 2: The base model is generated based on the input depth and a previous base model, independent of a previous detailed model.

The following steps (1) to (3) are performed as main steps of the second embodiment.

(1) Extract a frame with high quality from an input depth as a selection depth.

(2) Generate a base model, based on the selection depth.

(3) Generate a detailed model from the base model and the input depth.

Image Processing Apparatus 71

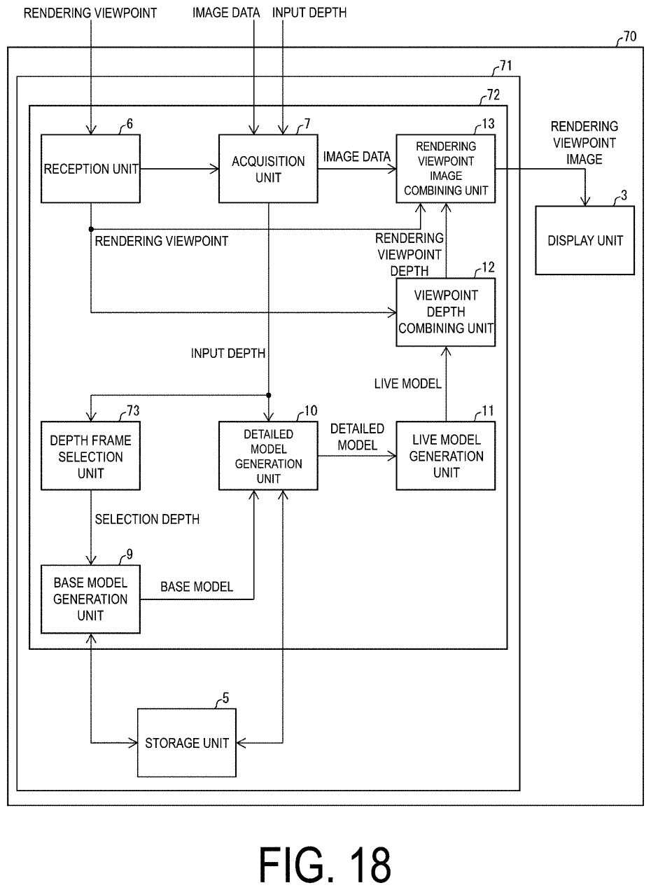

An image processing apparatus 71 according to the present embodiment will be described with reference to FIG. 18. FIG. 18 is a block diagram illustrating a configuration of a display apparatus 70 according to the present embodiment. As illustrated in FIG. 18, the display apparatus 70 has the same configuration as the display apparatus 1 according to the first embodiment except that the image processing unit 72 of the image processing apparatus 71 includes a depth frame selection unit 73 instead of the depth region selection unit 8.

The depth frame selection unit 73 selects a selection frame from frames constituted by the input depth acquired by the acquisition unit 7.

Image Processing Method

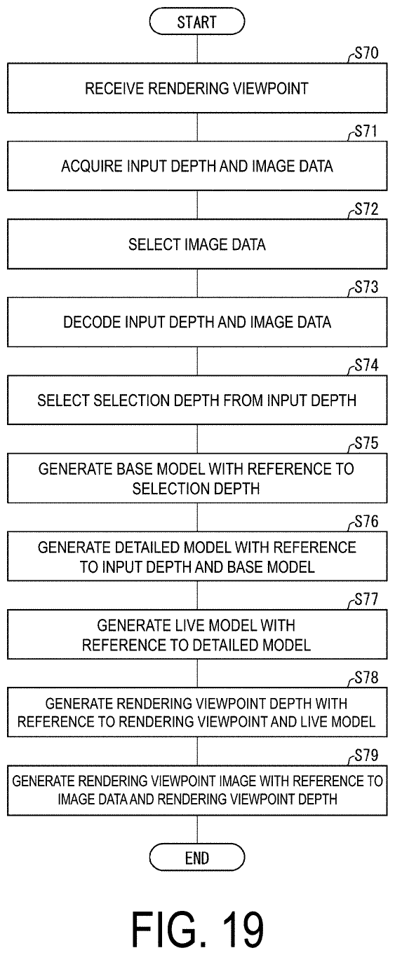

An image processing method by the image processing apparatus 71 according to the present embodiment will be described in detail with reference to FIG. 19. FIG. 19 is a flowchart diagram for illustrating an example of an image processing method by the image processing apparatus 71 according to the present embodiment. Note that the same steps as the image processing method according to the first embodiment are omitted from the detailed description.

First, the reception unit 6 receives a rendering viewpoint (information related to a rendering viewpoint) from the outside of the image processing apparatus 2 (step S70). The reception unit 6 transmits the received rendering viewpoint to the acquisition unit 7, the viewpoint depth combining unit 12, and the rendering viewpoint image combining unit 13.

Next, the acquisition unit 7 acquires image data of the imaging target and an input depth (input depth at each time) for indicating the three-dimensional shape of the imaging target (step S71).

Next, the acquisition unit 7 selects image data to be decoded in the acquired image data in accordance with the rendering viewpoint received by the reception unit 6 (step S72).

Next, the acquisition unit 7 decodes the selected image data and the acquired input depth (step S73). Then, the acquisition unit 7 transmits the decoded image data to the rendering viewpoint image combining unit 13, and transmits the decoded input depth to the depth frame selection unit 73 and the detailed model generation unit 10.

Next, the depth frame selection unit 73 selects a selection frame from the frames constituted by the input depth acquired by the acquisition unit 7 (step S74). Then, the depth frame selection unit 73 transmits the selected selection frame to the base model generation unit 9.

Next, the base model generation unit 9 generates (updates) a base model with reference to the selection depth included in the selection frame received from the depth frame selection unit 73 (step S75). Then, the base model generation unit 9 transmits the generated base model to the detailed model generation unit 10. Note that in a case that a selection depth is not received at a time that a frame is not selected, since the depth frame selection unit 73 has not selected a selection frame in step S74 described above, the base model generation unit 9 may output a previously generated base model to the detailed model generation unit 10 without updating the base model as a processing corresponding to that time. The base model generation unit 9 may output information for indicating whether or not the base model of the time has been updated to the detailed model generation unit 10.

Next, the detailed model generation unit 10 generates (updates) a detailed model with reference to the input depth received from the acquisition unit 7 and the base model received from the base model generation unit 9 (step S76). Then, the detailed model generation unit 10 transmits the generated detailed model and a deformation parameter described below to the live model generation unit 11.

Next, the live model generation unit 11 generates a live model with reference to the detailed model and the deformation parameter received from the detailed model generation unit 10 (step S77). Then, the live model generation unit 11 transmits the generated live model to the viewpoint depth combining unit 12.

Next, the viewpoint depth combining unit 12 generates a rendering viewpoint depth, which is a depth from the rendering viewpoint to each portion of the imaging target, with reference to the rendering viewpoint received from the reception unit 6 and the live model generated by the live model generation unit 11 (step S78). Then, the viewpoint depth combining unit 12 transmits the generated rendering viewpoint depth to the rendering viewpoint image combining unit 13.

Next, the rendering viewpoint image combining unit 13 generates a rendering viewpoint image indicating the imaging target from the rendering viewpoint, with reference to the rendering viewpoint received from the reception unit 6, the image data received from the acquisition unit 7, and the rendering viewpoint depth received from the viewpoint depth combining unit 12 (step S79). Then, the rendering viewpoint image combining unit 13 transmits the generated rendering viewpoint image to the display unit 3. The display unit 3 displays the rendering viewpoint image received from the rendering viewpoint image combining unit 13.

Specific Example of Depth Frame Selection Unit

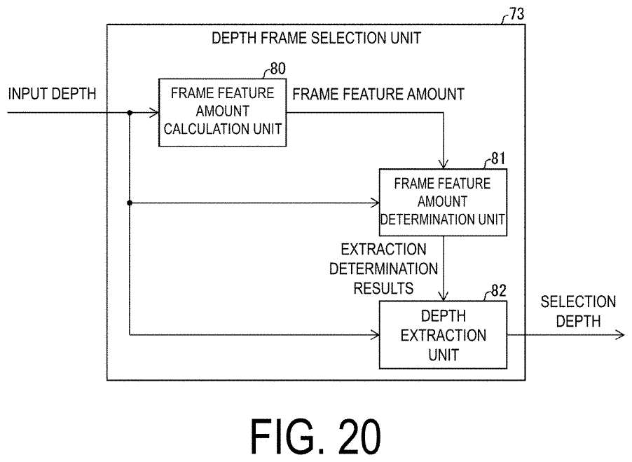

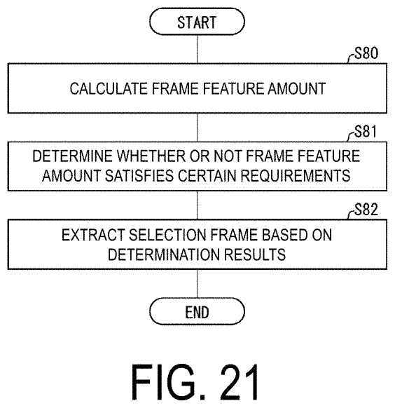

A specific example of a method for selecting a selection frame by the depth frame selection unit 73 in step S74 described above will be described below with reference to FIG. 20 and FIG. 21. FIG. 20 is a block diagram illustrating a configuration of the depth frame selection unit 73 according to the present specific example. As illustrated in FIG. 20, the depth frame selection unit 73 according to the present specific example includes a frame feature amount calculation unit 80, a frame feature amount determination unit 81, and a depth extraction unit 82. FIG. 21 is a flowchart diagram for illustrating a method for selecting a selection frame by the depth frame selection unit 73 according to the present specific example.

First, the frame feature amount calculation unit 80 calculates an amount of frame feature, based on the properties of the input depth received from the acquisition unit 7, and transmits the calculated frame feature amount to the frame feature amount determination unit 81 (step S80).

Next, the frame feature amount determination unit 81 determines whether or not the frame feature amount received from the frame feature amount calculation unit 80 satisfies specific requirements in the base model of the applying target, and outputs the determination results to the depth extraction unit 82 (step S81). More specifically, for example, the frame feature amount determination unit 81 determines whether or not the noise, which is the frame feature amount received from the frame feature amount calculation unit 80, is less than or equal to a prescribed value.

The depth extraction unit 82 extracts a selection frame, based on the determination results received from the frame feature amount determination unit 81, from the frames constituted by the input depth received from the acquisition unit 7, and outputs the extracted selection frame to the base model generation unit 9 (step S82).

As described above, the depth frame selection unit 73 (frame selection unit) according to the present specific example includes a frame feature amount calculation unit 80 configured to calculate an amount of frame feature of an input depth, and a depth extraction unit 82 (frame extraction unit) configured to extract a selection frame from the frames constituted by the input depth with reference to the frame feature amount.

According to the configuration described above, a frame with high reliability can be selected as a selection depth, based on an amount of frame feature. Accordingly, a base model with high reliability based on the selection depth can be generated, and deviation between the shape of the detailed model and the shape of the imaging target can be suppressed.

Specific Example of Depth Frame Selection Method

A specific example of the depth frame selection method by the depth frame selection unit 73 described above will be described below. First, an example of a target to be selected as a selection frame by the depth frame selection unit 73 by using the frame feature amount determination in steps S80 to S82 described above will be described.

For example, the depth frame selection unit 73 may be configured to select a frame encoded as an I picture (excluding B picture). In other words, the depth frame selection unit 73 may be configured to select a depth image decoded by using only an intra-picture prediction as a prediction scheme.

In another example, the depth frame selection unit 73 may be configured to select a frame encoded as a random access picture (excluding non-random access picture). In other words, the depth frame selection unit 73 may be configured to select a depth image decoded from encoded data to which an identifier meaning capable of random access is enabled.

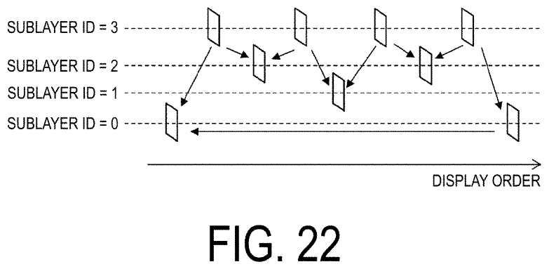

In another example, the depth frame selection unit 73 may be configured to select a frame of which the sublayer ID is less than or equal to a prescribed value (excluding a sublayer ID greater than a prescribed value). FIG. 22 is a schematic diagram illustrating an example of sublayer IDs. In FIG. 22, frames from which arrows are originating are frames of reference sources in the motion compensation prediction, and frames to which the arrows are oriented are frames of reference destinations with respect to the reference sources. In FIG. 22, it is more likely that the frame with a smaller value of sublayer ID is a frame with higher quality.

In another example, the depth frame selection unit 73 may be configured to select a frame in which a representative quantization parameter (QP) of the frame is less than or equal to a prescribed value.

By employing each of the configurations described above, it is possible to improve the quality of the base model since the depth quality of the selection frame is likely to be better (such as low noise) compared to excluded frames.

Next, an example for selecting a selection frame by the depth frame selection unit 73 according to whether or not an occlusion region is included in steps S80 to S82 described above will be described. For example, the depth frame selection unit 73 may be configured to select a frame in which no excessive occlusion is present from the frames constituted by the input depth acquired by the acquisition unit 7. More specifically, in step S81 described above, the frame feature amount determination unit 81 may determine that an excessive occlusion is present in the target frame in a case that the proportion of the occlusion region (for example, the region where the depth is smaller than a prescribed value (front region)) of the target frame is greater than or equal to a certain value. By employing the configuration described above, the quality of the base model can be maintained even in a case that an unintended target is temporarily included in the input depth.

Next, an example for selecting a selection frame by the depth frame selection unit 73 according to whether or not noise is present in steps S80 to S82 described above will be described. For example, the depth frame selection unit 73 may be configured to select a frame in which no excessive noise is present from the frames constituted by the input depth acquired by the acquisition unit 7. More specifically, in step S81 described above, the frame feature amount determination unit 81 may determine that no excessive noise is present in the target frame in a case that the proportion of the region in which the noise in the target frame is estimated to be strong (for example, a region where the variance is greater than or equal to a prescribed value) is less than or equal to a certain value. By employing the configuration described above, the quality of the base model can be maintained even in a case that noise is temporarily included in the input depth, such as the effect of illumination.

Next, an example for selecting a selection frame by the depth frame selection unit 73 according to the presence or absence of a target of a base model (e.g., a person) in steps S80 to S82 described above will be described. For example, the depth frame selection unit 73 may be configured to select a frame including a target of a base model from the frames constituted by the input depth acquired by the acquisition unit 7. More specifically, the frame feature amount determination unit 81 may apply a detection processing of a target of a base model for the target frame in step S81 described above, and may determine that the target of the base model is included in a case that the accuracy of the detection is greater than or equal to a certain degree. Then, in step S82 described above, the depth extraction unit 82 may extract the target frame as a selection frame. By employing the configuration described above, the base model does not deteriorate even in a case that an input depth corresponding to the target of the base model cannot be temporarily received (in a case that the target temporarily moves outside of the imaging range and then returns to the imaging range).

Modification of Depth Frame Selection Unit

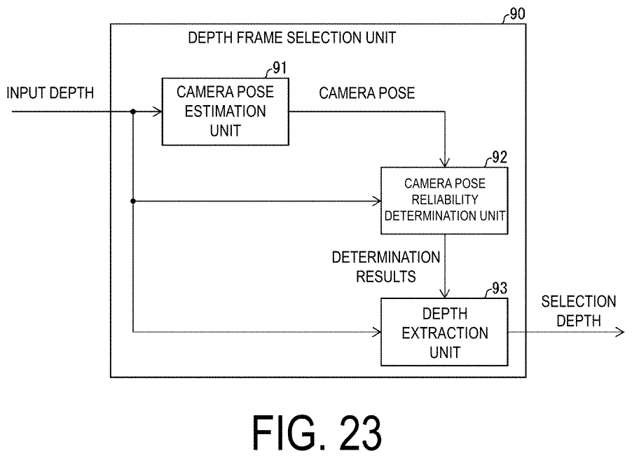

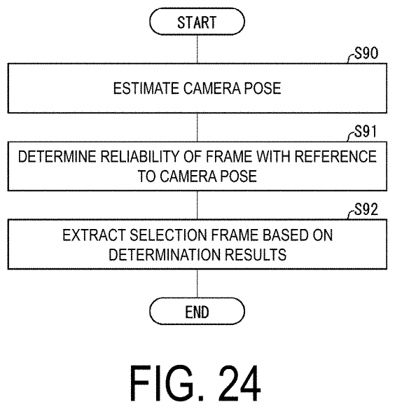

A modification of a method for selecting a selection frame by the depth frame selection unit 73 in step S74 described above will be described below with reference to FIG. 23 and FIG. 24. FIG. 23 is a block diagram illustrating a configuration of the depth frame selection unit 90 according to the present modification. As illustrated in FIG. 23, the depth frame selection unit 90 according to the present modification includes a camera pose estimation unit 91, a camera pose reliability determination unit 92, and a depth extraction unit 93. FIG. 24 is a flowchart diagram for illustrating a method of selecting a selection frame by the depth frame selection unit 90 according to the present modification.

First, the camera pose estimation unit 91 estimates a camera pose (change in camera position or change in camera orientation from a prescribed time), based on the input depth received from the acquisition unit 7 (step S90). More particularly, for example, the camera pose estimation unit 91 may extract feature points of the input depth and estimate the camera pose change by comparing the feature points to feature points in a previous frame.

Next, the camera pose reliability determination unit 92 determines the reliability of the target frame by comparing the input camera pose to a previous camera pose (step S91). More specifically, for example, the camera pose reliability determination unit 92 determines that the frame corresponding to the camera pose has high reliability in a case that the change in time of the camera poses (change between two times, or the degree of variation over multiple times) is small.

Next, the depth extraction unit 93 outputs the frame determined to have high reliability by the camera pose reliability determination unit 92 as a selection frame to the base model generation unit 9 (step S92).

As described above, the depth frame selection unit 90 (frame selection unit) according to the present modification includes a camera pose estimation unit 91 configured to estimate a camera pose of a camera by which the imaging target is imaged, with reference to an input depth, and a depth extraction unit 93 (frame extraction unit) configured to extract a selection frame from the frames constituted by the input depth with reference to the camera pose.

According to the configuration described above, a frame with high reliability can be selected as a selection frame, based on a camera pose, and the frequency that a large deterioration of a base model occurs by using a wrong camera pose to construct the base model can be reduced. Accordingly, a base model with high reliability based on the selection depth can be generated, and deviation between the shape of the detailed model and the shape of the imaging target can be suppressed.

### Summary of Second Embodiment

As described above, the image processing apparatus 71 according to the present embodiment further includes a depth frame selection unit 73 (frame selection unit) configured to select a selection frame from the frames constituted by an input depth acquired by the acquisition unit 7, and the base model generation unit 9 generates a base model with reference to a selection depth included in the selection frame.

According to the configuration described above, in a case that there is a time variation in the quality of the input depth, by selecting a frame with high reliability as a selection depth as appropriate, a base model with high reliability based on the selection depth can be generated. Accordingly, deviation between the shape of the detailed model and the shape of the imaging target can be suppressed.

### Third Embodiment

The third embodiment of the present invention will be described as follows with reference to the drawings. Note that, members having the same functions as the members included in the image processing apparatus 2 described in the first embodiment are added the same signs and description thereof will be omitted.

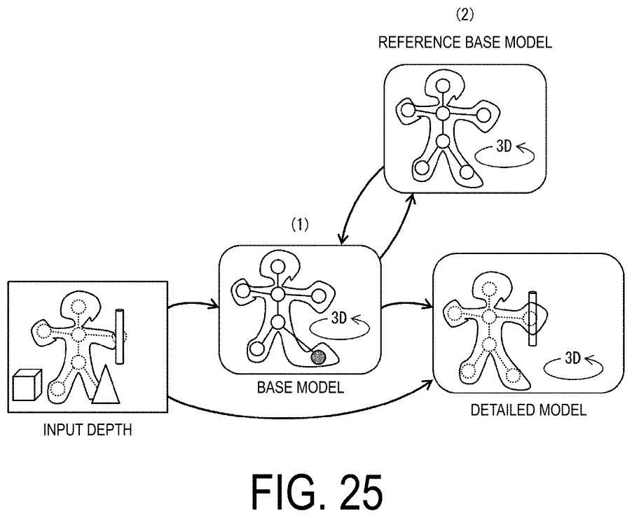

First, an overview of the third embodiment of the present invention will be described with reference to FIG. 25. FIG. 25 is a schematic diagram for illustrating an overview of the third embodiment of the present invention. The features of the third embodiment of the present invention include the following two points.

Feature 1: A base model is generated by using a reference base model constructed by selecting a portion with high reliability from a previous base model.

Feature 2: The base model is generated based on an input depth and the previous base model, independent of a previous detailed model.

The following steps (1) and (2) are performed as main steps of the third embodiment.

(1) Generate a base model by using a reference base model.

(2) Construct a reference base model by using a portion with high reliability of the base model.

Image Processing Apparatus 101

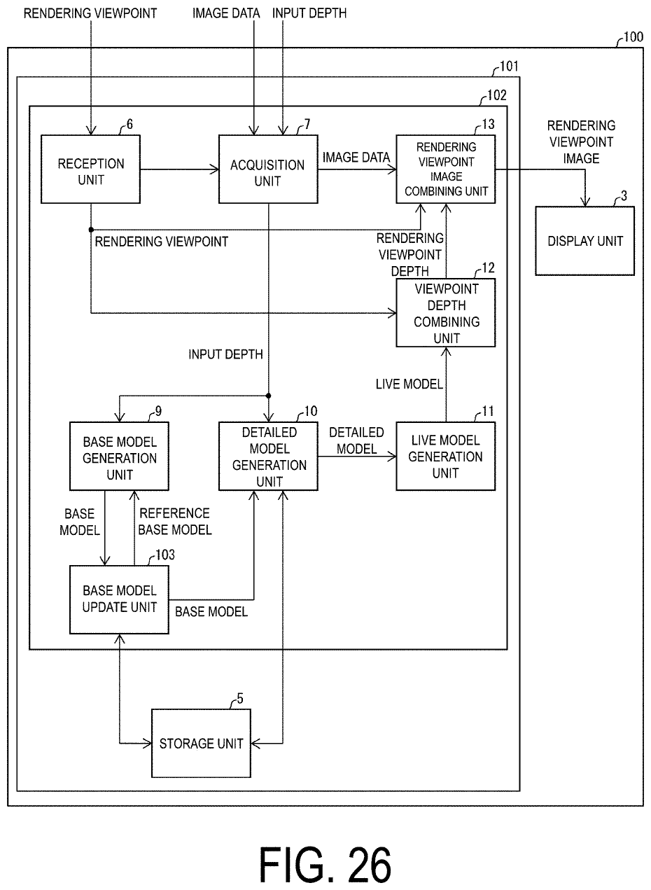

An image processing apparatus 101 according to the present embodiment will be described with reference to FIG. 26. FIG. 26 is a block diagram illustrating a configuration of a display apparatus 100 according to the present embodiment. As illustrated in FIG. 26, the display apparatus 100 has the same configuration as the display apparatus 100 according to the first embodiment except that the image processing unit 102 of the image processing apparatus 101 includes a base model update unit 103 instead of the depth region selection unit 8.

The base model update unit 103 (which serves as a portion selection unit and a reference base model generation unit) selects a reference portion from the base model received from the base model generation unit 9, and generates a reference base model with reference to the reference model.

Image Processing Method

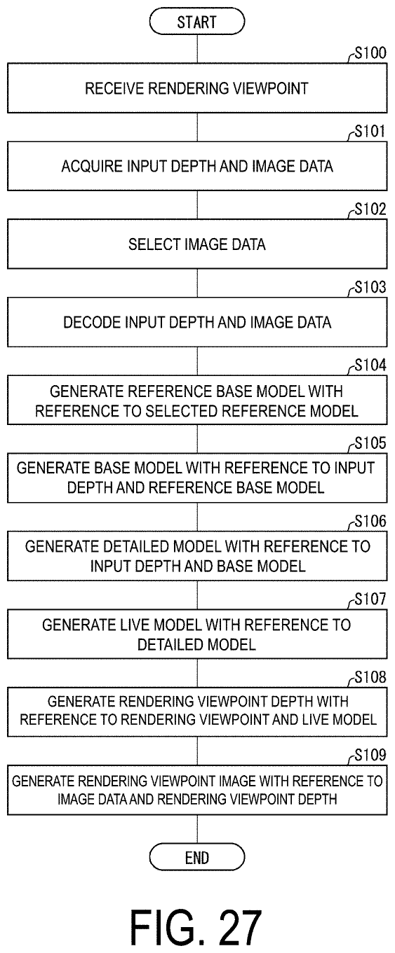

An image processing method by the image processing apparatus 101 according to the present embodiment will be described in detail with reference to FIG. 27. FIG. 27 is a flowchart diagram for illustrating an example of an image processing method by the image processing apparatus 101 according to the present embodiment. Note that the same steps as the image processing method according to the first embodiment are omitted from the detailed description.

First, the reception unit 6 receives a rendering viewpoint (information related to a rendering viewpoint) from the outside of the image processing apparatus 2 (step S100). The reception unit 6 transmits the received rendering viewpoint to the acquisition unit 7, the viewpoint depth combining unit 12, and the rendering viewpoint image combining unit 13.

Next, the acquisition unit 7 acquires image data of the imaging target and an input depth (input depth at each time) for indicating the three-dimensional shape of the imaging target (step S101).

Next, the acquisition unit 7 selects image data to be decoded in the acquired image data in accordance with the rendering viewpoint received by the reception unit 6 (step S102).

Next, the acquisition unit 7 decodes the selected image data and the acquired input depth (step S103). Then, the acquisition unit 7 transmits the decoded image data to the rendering viewpoint image combining unit 13, and transmits the decoded input depth to the base model generation unit 9 and the detailed model generation unit 10.

Next, the base model update unit 103 selects a reference portion from the base model previously generated by the base model generation unit 9, and generates (updates) a reference base model with reference to the reference model (step S104). Then, the base model update unit 103 transmits the reference base model to the base model generation unit 9.

Next, the base model generation unit 9 generates (updates) a base model with reference to the input depth received from the acquisition unit 7 and the reference base model received from the base model update unit 103 (step S105). Then, the base model generation unit 9 transmits the generated base model to the detailed model generation unit 10. Note that, in a case that the base model update unit 103 does not generate a reference base model since a base model has not been previously generated, the base model generation unit 9 may generate a base model only from the input depth received from the acquisition unit 7.

Next, the detailed model generation unit 10 generates (updates) a detailed model with reference to the input depth received from the acquisition unit 7 and the base model received from the base model generation unit 9 (step S106). Then, the detailed model generation unit 10 transmits the generated detailed model and a deformation parameter described below to the live model generation unit 11.

Next, the live model generation unit 11 generates a live model with reference to the detailed model and the deformation parameter received from the detailed model generation unit 10 (step S107). Then, the live model generation unit 11 transmits the generated live model to the viewpoint depth combining unit 12.

Next, the viewpoint depth combining unit 12 generates a rendering viewpoint depth, which is a depth from the rendering viewpoint to each portion of the imaging target, with reference to the rendering viewpoint received from the reception unit 6 and the live model generated by the live model generation unit 11 (step S108). Then, the viewpoint depth combining unit 12 transmits the generated rendering viewpoint depth to the rendering viewpoint image combining unit 13.

Next, the rendering viewpoint image combining unit 13 generates a rendering viewpoint image indicating the imaging target from the rendering viewpoint, with reference to the rendering viewpoint received from the reception unit 6, the image data received from the acquisition unit 7, and the rendering viewpoint depth received from the viewpoint depth combining unit 12 (step S109). Then, the rendering viewpoint image combining unit 13 transmits the generated rendering viewpoint image to the display unit 3. The display unit 3 displays the rendering viewpoint image received from the rendering viewpoint image combining unit 13.

### Details of Third Embodiment (Base Model Update Unit 103)

Definition

The following lists definitions of data used by the base model update unit 103 or the base model generation unit 9 according to the present embodiment.

Base model M: Set of base nodes {Ni|i=1, . . . , n} n is the number of base nodes

Reference base model M′: Set of base nodes {Ni′|i=1, . . . , n} n is the number of base nodes

Base Model Update

Derive the reference base model M′^{t} from the base model M^{t}, the base model M^{t-1} (corresponding to step S104 described above)

1) Determine whether or not the deformation parameter of the base node of the base model M^{t} is reliable, and if not, utilize the deformation parameter of the base model M^{t-1}

A deformation parameter satisfying any of the following conditions is determined to be unreliable
Change in deformation is greater than a prescribed threshold value (width of translation is larger, rotation is larger)
The base node position after deformation does not satisfy a prescribed criterion
Example) in a case that there is a correspondence between the base node and joint, the deformation node is moved or rotated to a position that is not possible in terms of the human anatomy
Mismatched with deformation of nearby deformation nodes
Example) the difference of the deformation parameter with a nearby deformation node is greater than a prescribed value

2) Determine whether or not the deformation parameter of the base model M^{t} and the base model M^{t-1} is reliable, and if not, complement from a deformation parameter of a nearby base node

In a case that the following conditions are satisfied, it is determined to be unreliable
In a case that a deformation parameter of a particular base node Ni is not updated for a certain period of time
In a case that there is a large variation in the deformation parameter of the particular base node Ni during a period of time

### Summary of Third Embodiment

As described above, the image processing apparatus 101 according to the present embodiment further includes a base model update unit (which serves as a portion selection unit and a reference base model generation unit) configured to select a reference portion from the base model described above, and generate a reference base model with reference to the reference portion, and the base model generation unit 9 updates the base model with reference to the reference base model.

According to the configuration described above, a reference portion with high reliability can be selected as appropriate, a reference base model with high reliability based on the reference portion can be generated, and a base model with high reliability can be generated based on the reference base model. This can suppress the influence on a subsequent base model even in a case that the quality of the base model begins to deteriorate. This can suppress the influence on a subsequent detailed model even in a case that the quality of the detailed model begins to deteriorate as well. Accordingly, deviation between the shape of the detailed model and the shape of the imaging target can be suppressed.

### Fourth Embodiment

The fourth embodiment of the present invention will be described as follows. In the first to third embodiments described above, a configuration has been described in which a rendering viewpoint image is generated by using a detailed model according to an aspect of the present invention (a detailed model based on a base model), but the image processing method using a detailed model according to an aspect of the present invention is not limited to the configuration. For example, as an embodiment of the present invention, a configuration of a three-dimensional model generation apparatus configured to generate a detailed model (a three-dimensional model) based on a base model may be employed.

More specifically, the three-dimensional model generation apparatus according to an aspect of the present embodiment includes the depth region selection unit 8, the base model generation unit 9, and the detailed model generation unit 10 described in the first embodiment. In this configuration, the depth region selection unit 8 selects a selection depth from the received input depth. Next, the base model generation unit 9 generates (updates) a base model with reference to the selection depth selected by the depth region selection unit 8. Next, the detailed model generation unit 10 generates (updates) a detailed model with reference to the received input depth and the base model generated by the base model generation unit 9.

A three-dimensional model generation apparatus according to another aspect of the present embodiment includes the depth frame selection unit 73, the base model generation unit 9, and the detailed model generation unit 10 described in the second embodiment. In this configuration, the depth frame selection unit 73 selects a selection frame from the frames constituted by the received input depth. Next, the base model generation unit 9 generates (updates) a base model with reference to the selection depth included in the selection frame selected by the depth frame selection unit 9. Next, the detailed model generation unit 10 generates (updates) a detailed model with reference to the received input depth and the base model generated by the base model generation unit 9.

A three-dimensional model generation apparatus according to yet another aspect of the present embodiment includes the base model update unit 103, the base model generation unit 9, and the detailed model generation unit 10 described in the third embodiment. In this configuration, the base model update unit 103 selects a reference portion from the base model previously generated by the base model generation unit 9, and generates (updates) a reference base model with reference to the reference model. Next, the base model generation unit 9 generates (updates) a base model with reference to the received input depth and the reference base model generated by the base model update unit 103. The detailed model generation unit 10 generates (updates) a detailed model with reference to the received input depth and the base model generated by the base model generation unit 9.

By employing the configurations described above, in each of the aspects described above, a detailed model with high reliability based on a base model (a detailed model in which deviation from the shape of the imaging target is suppressed) can be generated. As a result, in the technical field of three-dimensional imaging, a detailed model with high reliability can be used as appropriate.

Supplemental Note

Supplemental notes of the first to fourth embodiments described above will be described below.

Three or More Model Layers

The image processing method according to the first to fourth embodiments described above has a two-layer configuration in which the base model generation unit 9 generates a base model and the detailed model generation unit 10 generates a detailed model with reference to the base model. However, the configuration is not limited to this configuration, and a configuration of three or more layers may be employed to generate an additional three-dimensional model other than a base model and a detailed model.

More specifically, a second base model generation unit may further be provided that is further configured to generate a second base model, and the second base model generation unit may generate a second base model. In this case, the base model generation unit 9 generates a first base model with reference to the second base model, and the detailed model generation unit 10 generates a detailed model with reference to the first base model. By employing the configuration as described above, the process becomes complicated, but a more accurate three-dimensional model can be generated. Note that in the configuration, a more defined input depth is preferably used for a model for a higher layer (in the above example, the second base model).

### Combination of First Embodiment and Second Embodiment

A configuration in which the first embodiment (spatial selection) and the second embodiment (time selection) described above are combined may be employed. As a result, the process becomes complicated by using the combination, but a base model with higher reliability can be constructed.

Format of Base Model and Detailed Model

The format of a base model generated by the base model generation unit 9 described above is not limited to a mesh representation, but may be another expression. More particularly, for example, the base model generation unit 9 may generate a base model of a volume representation (TSDF representation). Another expression may be used as a format for a detailed model as well.

In the descriptions of the first to fourth embodiments, a base model and a detailed model need not necessarily be consistently the same representation. In a case that models are expressed in different formats, the configurations of the embodiments can be modified to convert the base model or the detailed model into a form, such as a mesh representation, for use if necessary.

Combination of Information Other Than Depth

The depth region selection unit 8 according to the first embodiment may utilize information other than an input depth to select a region. The depth frame selection unit 73 according to the second embodiment may utilize information other than an input depth to select a frame. More specifically, for example, the depth region selection unit 8 may further acquire an RGB image (image data) from the acquisition unit 7, and select a region of the RGB image that is recognized as a person as a selection depth (in the case of the depth frame selection unit 73, a frame including the region is selected as a selection frame). In another example, the depth region selection unit 8 may select a region in which the outlines of the RGB image and the input depth match as a selection depth (in the case of the depth frame selection unit 73, a frame including the region is selected as a selection frame). In another example, the depth region selection unit 8 may select a region in which a marker is detected as a selection depth (in the case of the depth frame selection unit 73, a frame including the region is selected as a selection frame). By employing each of the configurations described above, necessary data increases, but a base model with higher reliability can be constructed.

Referring to Base Model Intermittently

The detailed model generation unit 10 may generate a detailed model with reference to only an input model without reference to a base model. In this case, the detailed model generation unit 10 generates a detailed model without reference to a base model for a prescribed period of time, and generates a detailed model intermittently with reference to a base model. By employing the configuration described above, the deterioration of a detailed model continues for a certain period of time, but the amount of processing of the generation of a detailed model can be reduced.

Implementation Examples by Software

Control blocks of the image processing apparatus 101 (particularly the depth region selection unit 8, the base model generation unit 9, and the depth frame selection unit 73) may be implemented by a logic circuit (hardware) formed in an integrated circuit (IC chip) or the like, or may be implemented by software.

In the latter case, the image processing apparatus 101 includes a computer configured to perform instructions of a program that is software for realizing each of the functions. The computer includes at least one processor (control device), for example, and includes at least one computer-readable recording medium having the program stored thereon. In the computer, the processor reads the program from the recording medium and performs the program to achieve the object of the present invention. A Central Processing Unit (CPU) can be used as the processor, for example. As the above-described recording medium, a “non-transitory tangible medium”, for example, a Read Only Memory (ROM) or the like, or a tape, a disk, a card, a semiconductor memory, a programmable logic circuit, or the like can be used. A Random Access Memory (RAM) for deploying the above-described program or the like may be further provided. The above-described program may be supplied to the above-described computer via an arbitrary transmission medium (such as a communication network and a broadcast wave) capable of transmitting the program. Note that an aspect of the present invention may also be implemented in a form of a data signal embedded in a carrier wave in which the program is embodied by electronic transmission.

Supplement

An image processing apparatus (1, 70, 100) according to the first aspect of the present invention includes: an acquisition unit (7) configured to acquire an input depth for indicating a three-dimensional shape of an imaging target; a base model generation unit (9, 50) configured to generate a base model based on a part of the input depth acquired by the acquisition unit; and a detailed model generation unit (10) configured to generate a detailed model of the imaging target, with reference to the input depth and the base model.

According to the configuration described above, unlike a case that a detailed model is generated directly from an input depth, a base model is first generated and the base model is further referenced to generate a detailed model. Accordingly, by generating a base model, based on data with high reliability as appropriate, deviation between the shape of a detailed model and the shape of an imaging target can be suppressed (a reduction in the quality of a detailed model can be suppressed). Even in a case that the shape of the detailed model and the shape of the imaging target begin to be diverted, it is possible to suppress influence of the deviation to the base model, and the reliability of the base model can be maintained. Accordingly, deviation between the shape of the detailed model and the shape of the imaging target can be suppressed.

An image processing apparatus (1) according to the second aspect of the present invention may further include, in the first aspect described above, a depth selection unit (depth region selection unit 8, 30) configured to select a selection depth from the input depth acquired by the acquisition unit, and the base model generation unit may generate the base model with reference to the selection depth.

According to the configuration described above, by selecting a selection depth with high reliability as appropriate, a base model with high reliability based on the selection depth can be generated. Accordingly, deviation between the shape of the detailed model and the shape of the imaging target can be suppressed.

An image processing apparatus (1) according to the third aspect of the present invention may include, in the second aspect described above, the depth selection unit (depth region selection unit 8) including a segmentation unit (20) configured to segment the input depth, and a selection depth extraction unit (depth extraction unit 22) configured to extract an input depth corresponding to the imaging target as the selection depth from the input depth resulting from the segmentation by the segmentation unit.

According to the configuration described above, an input depth with high reliability can be selected as a selection depth by extracting a segment with high reliability by determining the reliability of the input depth segment with a prescribed criterion. Accordingly, a base model with high reliability based on the selection depth can be generated, and deviation between the shape of the detailed model and the shape of the imaging target can be suppressed.

An image processing apparatus (1) according to the fourth aspect of the present invention may include, in the second aspect described above, the depth selection unit (depth region selection unit 30) including a local feature amount calculation unit (31) configured to calculate an amount of local feature of the input depth, and a selection depth extraction unit (depth extraction unit 33) configured to extract the selection depth from the input depth with reference to the amount of local feature.

According to the configuration described above, an input depth with high reliability can be selected as a selection depth, based on an amount of local feature. Accordingly, a base model with high reliability based on the selection depth can be generated, and deviation between the shape of the detailed model and the shape of the imaging target can be suppressed.

An image processing apparatus (1) according to the fifth aspect of the present invention may include, in the second to fourth aspects described above, the base model generation unit including a deformation parameter estimation unit (base model deformation estimation unit 40) configured to estimate a deformation parameter of the selection depth and the generated base model, and a base model deformation unit (base model deformation unit 41) configured to update the base model by deforming the generated base model by using the deformation parameter.

According to the configuration described above, the base model can be updated based on the deformation parameter of the selection depth and the generated base model. As a result, a base model with high reliability can be generated, and deviation between the shape of the detailed model and the shape of the imaging target can be suppressed.

An image processing apparatus (1) according to the sixth aspect of the present invention may include, in the second to fourth aspects described above, the base model generation unit including a deformation parameter estimation unit (base model deformation estimation unit 40) configured to estimate a deformation parameter of the selection depth and the generated base model, a reference base model generation unit (depth integration unit 51) configured to deform the selection depth by using the deformation parameter and generate a reference base model with reference to the selection depth, and a reference base model deformation unit (base model deformation unit 41) configured to update the base model by deforming the reference base model by using the deformation parameter.

According to the configuration described above, a base model can be updated by using a reference base model based on a deformation parameter of a selection depth and a generated base model. As a result, a base model with high reliability can be generated, and deviation between the shape of the detailed model and the shape of the imaging target can be suppressed.

An image processing apparatus (1) according to the seventh aspect of the present invention may include, in the second to sixth aspects described above, the detailed model generation unit including a base deformation parameter estimation unit (base deformation estimation unit 60) configured to estimate a base deformation parameter of the base model and the generated detailed model, a detailed model deformation parameter estimation unit (detailed model deformation estimation unit 61) configured to estimate a detailed model deformation parameter of a detailed model corresponding to the input depth and the generated detailed model, by using the base deformation parameter as an initial value, and a detailed model deformation unit (62) configured to update the detailed model by deforming the generated detailed model by using the detailed model deformation parameter.

According to the configuration described above, a detailed model deformation parameter can be estimated based on a base deformation parameter estimated from a base model. As a result, a detailed model can be updated by using a detailed model deformation parameter with high reliability, and thus deviation between the shape of the detailed model and the shape of the imaging target can be suppressed.

An image processing apparatus (71) according to the eighth aspect of the present invention may further include, in the first aspect described above, a frame selection unit (depth frame selection unit 73) configured to select a selection frame from the frames constituted by the input depth acquired by the acquisition unit, and the base model generation unit may generate the base model with reference to the selection depth included in the selection frame.

According to the configuration described above, in a case that there is a time variation in the quality of the input depth, by selecting a frame with high reliability as a selection depth as appropriate, a base model with high reliability based on the selection depth can be generated. Accordingly, deviation between the shape of the detailed model and the shape of the imaging target can be suppressed.

An image processing apparatus (71) according to the ninth aspect of the present invention may include, in the eighth aspect described above, the frame selection unit including a frame feature amount calculation unit (80) configured to calculate an amount of frame feature of the input depth, and a frame extraction unit (depth extraction unit 82) configured to extract the selection frame from the frames constituted by the input depth with reference to the amount of frame feature.

According to the configuration described above, a frame with high reliability can be selected as a selection frame, based on an amount of frame feature. Accordingly, a base model with high reliability based on the selection depth can be generated, and deviation between the shape of the detailed model and the shape of the imaging target can be suppressed.

An image processing apparatus (71) according to the tenth aspect of the present invention may include, in the eighth aspect described above, the frame selection unit including a camera pose estimation unit (91) configured to estimate a camera pose of a camera by which the imaging target is imaged, with reference to the input depth, and a frame extraction unit (depth extraction unit 93) configured to extract the selection frame from the frames constituted by the input depth, with reference to the camera pose.

According to the configuration described above, a frame with high reliability can be selected as a selection frame, based on a camera pose, and the frequency that a large deterioration of a base model occurs by using a wrong camera pose to construct the base model can be reduced. Accordingly, a base model with high reliability based on the selection depth can be generated, and deviation between the shape of the detailed model and the shape of the imaging target can be suppressed.

An image processing apparatus (101) according to the eleventh aspect of the present invention may further include, in the first aspect described above, a portion selection unit (base model update unit 103) configured to select a reference portion from the base model, and a reference base model generation unit (base model update unit 103) configured to generate a reference base model with reference to the reference portion, and the base model generation unit may update the base model with reference to the reference base model.

According to the configuration described above, a reference portion with high reliability can be selected as appropriate, a reference base model with high reliability based on the reference portion can be generated, and a base model with high reliability can be generated based on the reference base model. This can suppress the influence on a subsequent base model even in a case that the quality of the base model begins to deteriorate. This can suppress the influence on a subsequent detailed model even in a case that the quality of the detailed model begins to deteriorate as well. Accordingly, deviation between the shape of the detailed model and the shape of the imaging target can be suppressed.

A display apparatus (1, 70, 100) according to the twelfth aspect of the present invention includes: the image processing apparatus according to any one of the first to eleventh aspects described above; a combining unit (rendering viewpoint image combining unit 13) configured to generate a rendering viewpoint image for representing the imaging target from a rendering viewpoint with reference to the detailed model; and a display unit (3) configured to display the rendering viewpoint image.

According to the configuration described above, a rendering viewpoint image with high quality can be generated and displayed based on a detailed model in which deviation with the shape of the imaging target is suppressed.

An image processing method according to the thirteenth aspect of the present invention includes the steps of: acquiring an input depth for indicating a three-dimensional shape of an imaging target; generating a base model based on a part of the input depth acquired in the acquisition step; and generating a detailed model of the imaging target, with reference to the input depth and the base model.

According to the configuration described above, the same effect as that of the first aspect described above can be achieved.

The image processing apparatus according to each of the aspects of the present invention may be implemented by a computer. In this case, the present invention embraces also an image processing program of the image processing apparatus that implements the above image processing apparatus by a computer by causing the computer to operate as each unit (software element) included in the above image processing apparatus, and a computer-readable recording medium recording the program.

The present invention is not limited to each of the above-described embodiments. It is possible to make various modifications within the scope of the claims. An embodiment obtained by appropriately combining technical elements each disclosed in different embodiments falls also within the technical scope of the present invention. Further, in a case that technical elements disclosed in the respective embodiments are combined, it is possible to form a new technical feature.

### REFERENCE SIGNS LIST

1, 70, 100 Display apparatus
2, 71, 101 Image processing apparatus
3 Display unit
4, 72, 102 Image processing unit
5 Storage unit
6 Reception unit
7 Acquisition unit
8, 30 Depth region selection unit
9, 50 Base model generation unit
10 Detailed model generation unit
11 Live model generation unit
12 Viewpoint depth combining unit
13 Rendering viewpoint image combining unit
20 Segmentation unit
21 Segment determination unit
22, 33, 82, 93 Depth extraction unit
31 Local feature amount calculation unit
32 Local feature amount comparison unit
40 Base model deformation estimation unit
41 Base model deformation unit
42 Base model accumulation unit
51 Depth integration unit
60 Base deformation estimation unit
61 Detailed model deformation estimation unit
62 Detailed model deformation unit
63 Detailed model accumulation unit
73, 90 Depth frame selection unit
80 Frame feature amount calculation unit
81 Frame feature amount determination unit
91 Camera pose estimation unit
92 Camera pose reliability determination unit
103 Base model update unit

1. An image processing apparatus comprising:
an acquisition circuit configured to acquire an input depth for indicating a three-dimensional shape of an imaging target;
a base model generation circuit configured to generate a base model based on a part of the input depth acquired by the acquisition circuit; and
a detailed model generation circuit configured to generate a detailed model of the imaging target, with reference to the input depth and the base model.

2. The image processing apparatus according to claim 1, further comprising:
a depth selection circuit configured to select a selection depth from the input depth acquired by the acquisition circuit, wherein
the base model generation circuit generates the base model with reference to the selection depth.

3. The image processing apparatus according to claim 2, wherein
the depth selection circuit includes:
a segmentation circuit configured to segment the input depth; and
a selection depth extraction circuit configured to extract an input depth corresponding to the imaging target as the selection depth from the input depth resulting from the segmentation by the segmentation circuit.

4. The image processing apparatus according to claim 2, wherein
the depth selection circuit includes:
a local feature amount calculation circuit configured to calculate an amount of local feature of the input depth; and
a selection depth extraction circuit configured to extract the selection depth from the input depth, with reference to the amount of local feature.

5. The image processing apparatus according to claim 2, wherein
the base model generation circuit includes:
a deformation parameter estimation circuit configured to estimate a deformation parameter of the selection depth and the generated base model; and
a base model deformation circuit configured to update the base model by deforming the generated base model by using the deformation parameter.

6. The image processing apparatus according to claim 2, wherein
the base model generation circuit includes:
a deformation parameter estimation circuit configured to estimate a deformation parameter of the selection depth and the generated base model;
a reference base model generation circuit configured to deform the selection depth by using the deformation parameter and generate a reference base model with reference to the selection depth; and
a reference base model deformation circuit configured to update the base model by deforming the reference base model by using the deformation parameter.

7. The image processing apparatus according to claim 2, wherein
the detailed model generation circuit includes:
a base deformation parameter estimation circuit configured to estimate a base deformation parameter of the base model and the generated detailed model;
a detailed model deformation parameter estimation circuit configured to estimate a detailed model deformation parameter of a detailed model corresponding to the input depth and the generated detailed model, with the base deformation parameter being an initial value; and
a detailed model deformation circuit configured to update the detailed model by deforming the generated detailed model by using the detailed model deformation parameter.

8. The image processing apparatus according to claim 1, further comprising:
a frame selection circuit configured to select a selection frame from frames constituted by the input depth acquired by the acquisition circuit, wherein
the base model generation circuit generates the base model with reference to a selection depth included in the selection frame.

9. The image processing apparatus according to claim 8, wherein
the frame selection circuit includes:
a frame feature amount calculation circuit configured to calculate an amount of frame feature of the input depth; and
a frame extraction circuit configured to extract the selection frame from the frames constituted by the input depth, with reference to the amount of frame feature.

10. The image processing apparatus according to claim 8, wherein
the frame selection circuit includes:
a camera pose estimation circuit configured to estimate a camera pose of a camera by which the imaging target is imaged, with reference to the input depth; and
a frame extraction circuit configured to extract the selection frame from the frames constituted by the input depth, with reference to the camera pose.

11. The image processing apparatus according to claim 1, further comprising:
a portion selection circuit configured to select a reference portion from the base model; and
a reference base model generation circuit configured to generate a reference base model with reference to the reference portion, wherein
the base model generation circuit updates the base model with reference to the reference base model.

12. A display apparatus comprising:
the image processing apparatus according to claim 1;
a combining circuit configured to generate a rendering viewpoint image for representing the imaging target from a rendering viewpoint with reference to the detailed model; and
a display circuit configured to display the rendering viewpoint image.

13. An image processing method comprising the steps of:
acquiring an input depth for indicating a three-dimensional shape of an imaging target;
generating a base model based on a part of the input depth acquired in the acquisition step; and
generating a detailed model of the imaging target, with reference to the input depth and the base model.

14. A non-transitory computer readable medium that stores a control program causing a computer to operate as the image processing apparatus according to claim 1, the control program causing a computer to operate as the acquisition circuit, the base model generation circuit, and the detailed model generation circuit.

15. (canceled)
